(19) United States
(12) Patent Application Publication
(10) Pub. No.: US 2025/0063591 A1
(43) Pub. Date: Feb. 20, 2025

(54) LINK RECOMMENDATION FOR MEETING QOS REQUIREMENTS

(71) Applicant: Samsung Electronics Co., Ltd., Suwon-si (KR)

(72) Inventors: Vishnu Vardhan Ratnam, Plano, TX (US); Boon Loong Ng, Plano, TX (US); Rubayet Shafin, Frisco, TX (US); Peshal Nayak, Plano, TX (US); Yue Qi, Plano, TX (US); Elliot Jen, Taipei City (TW); Abhishek Sehgal, Frisco, TX (US)

(21) Appl. No.: 18/781,981

(22) Filed: Jul. 23, 2024

Related U.S. Application Data
(60) Provisional application No. 63/532,480, filed on Aug. 14, 2023.
(60) Provisional application No. 63/544,556, filed on Oct. 17, 2023.

(51) Int. Cl. H04W 72/543; H04W 52/02

(52) U.S. Cl. CPC H04W 72/543; H04W 52/0229

(57) ABSTRACT

Methods and apparatuses for link recommendation for meeting QoS requirements. A method of wireless communication performed by an AP associated with an AP MLD, the method comprising: receiving an indication of quality of service (QoS) requirements from a non-AP MLD; determining whether an existing target wake time (TWT) or existing links are sufficient to meet QoS requirements; when the existing TWT or existing links are not sufficient to meet the QoS requirements, transmitting a message to the non-AP MLD indicating a need to negotiate additional TWT service periods (SPs) or to transition additional enabled links to an active mode or enable additional links with the AP MLD; and when the existing TWT or existing links are sufficient to meet the QoS requirements, scheduling uplink or downlink resources to meet the QoS requirements.

### CROSS-REFERENCE TO RELATED APPLICATION(S) AND CLAIM OF PRIORITY

This application claims priority under 35 U.S.C. § 119(e) to U.S. Provisional Patent Application No. 63/532,480 filed on Aug. 14, 2023, and U.S. Provisional Patent Application No. 63/544,556 filed on Oct. 17, 2023 which are hereby incorporated by reference in their entirety.

### TECHNICAL FIELD

This disclosure relates generally to wireless communications systems, and more particularly to methods and apparatus for link recommendation for meeting quality of service (QoS) requirements.

### BACKGROUND

Wireless local area network (WLAN) technology allows devices to access the internet in the 2.4 GHz, 5 GHz, 6 GHz or 60 GHz frequency bands. WLANs are based on the Institute of Electrical and Electronic Engineers (IEEE) 802.11 standards. The IEEE 802.11 family of standards aim to increase speed and reliability and to extend the operating range of wireless networks.

### SUMMARY

Embodiments of the present disclosure provide methods and apparatus for link recommendation for meeting QoS requirements.

In one embodiment, a method of wireless communication performed by an access point (AP) associated with an AP multi-link device (MLD), the method comprising: receiving an indication of quality of service (QoS) requirements from a non-AP MLD; determining whether an existing target wake time (TWT) or existing links are sufficient to meet QoS requirements; when the existing TWT or existing links are not sufficient to meet the QoS requirements, transmitting a message to the non-AP MLD indicating a need to negotiate additional TWT service periods (SPs) or to transition additional enabled links to an active mode or enable additional links with the AP MLD; and when the existing TWT or existing links are sufficient to meet the QoS requirements, scheduling uplink or downlink resources to meet the QoS requirements.

In another embodiment, an AP device includes a transceiver, and a processor operably coupled to the transceiver. The processor is configured to: receive an indication of QoS requirements from a non-AP MLD; determine whether an existing TWT or existing links are sufficient to meet QoS requirements; when the existing TWT or existing links are not sufficient to meet the QoS requirements, transmitting a message to the non-AP MLD indicating a need to negotiate additional TWT SPs or to transition additional enabled links to an active mode or enable additional links with the AP MLD; and when the existing TWT or existing links are sufficient to meet the QoS requirements, schedule uplink or downlink resources to meet the QoS requirements.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C. As used herein, such terms as “1st” and “2nd,” or “first” and “second” may be used to simply distinguish a corresponding component from another and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to various embodiments of the present disclosure;

FIG. 2A illustrates an example AP according to various embodiments of the present disclosure;

FIG. 2B illustrates an example STA according to various embodiments of the present disclosure;

FIG. 3 illustrates an example frame exchange sequence for the stream classification service (SCS) negotiation between a non-AP STA and an AP according to embodiments of the present disclosure;

FIG. 4 illustrates an example SCS Request frame format according to embodiments of the present disclosure;

FIG. 5 illustrates an example SCS Response frame format according to embodiments of the present disclosure;

FIG. 6 illustrates an example format of the QoS Characteristics element according to embodiments of the present disclosure;

FIG. 7 illustrates an example multi-link traffic indication element operation according to embodiments of the present disclosure;

FIG. 8 illustrates an example of enhanced multi-link single-radio (EMLSR) operation for a two-link non-AP MLD according to various embodiments of the present disclosure;

FIG. 9 illustrates an example of enhanced multi-link multi-radio (EMLMR) operation for a two-link non-AP MLD according to various embodiments of the present disclosure;

FIG. 10 illustrates an example of the SCS Response frame depicting the Status subfield according to various embodiments of the present disclosure;

FIG. 11 illustrates an example of the Status code values to be used in SCS Response frame according to various embodiments of the present disclosure;

FIG. 12 illustrates an example format of the Link Recommendation frame Action field according to various embodiments of the present disclosure;

FIG. 13 illustrates an example of the Reason Code values corresponding to the purpose of the Link Recommendation according to various embodiments of the present disclosure;

FIG. 14 illustrates an example format of an individually addressed action frame for link recommendation according to various embodiments of the present disclosure;

FIG. 15 illustrates an example of a new element for indication of the individually addressed link recommendation according to various embodiments of the present disclosure;

FIG. 16 illustrates another example of the SCS Response frame depicting the Status subfield according to various embodiments of the present disclosure;

FIG. 17 illustrates another example of the Status code values to be used in SCS Response frame according to various embodiments of the present disclosure;

FIG. 18 illustrates another example format of the Link Recommendation frame Action field according to various embodiments of the present disclosure;

FIG. 19 illustrates another example of the Reason Code values corresponding to the purpose of the Link Recommendation according to various embodiments of the present disclosure;

FIG. 20 illustrates another example format of an individually addressed action frame for link recommendation according to various embodiments of the present disclosure;

FIG. 21 illustrates another example of a new element for indication of the individually addressed link recommendation according to various embodiments of the present disclosure;

FIG. 22 illustrates an example flow diagram illustrating the sequence of steps performed by an AP to recommend the non-AP MLD to use more links or more target wake times (TWTs) for meeting QoS requirements according to various embodiments of the present disclosure;

FIG. 23 illustrates an example flow diagram illustrating the sequence of steps performed by an STA to meet QoS requirements of its traffic according to various embodiments of the present disclosure;

FIG. 24 illustrates yet another example format of the Link Recommendation frame Action field according to various embodiments of the present disclosure;

FIG. 25 illustrates yet another example of the Reason Code values corresponding to the purpose of the Link Recommendation according to various embodiments of the present disclosure;

FIG. 26 illustrates an example format of the Multi-link Recommendation Request frame Action field according to various embodiments of the present disclosure;

FIG. 27 illustrates an example of the EML Capabilities subfield indicating separately the EMLSR Support, EMLSR Capable, EMLMR Support and EMLMR Capable subfields according to various embodiments of the present disclosure; and

FIG. 28 illustrates a flow diagram of an example of a method for wireless communication performed by an access point device according to embodiments of the present disclosure.

### DETAILED DESCRIPTION

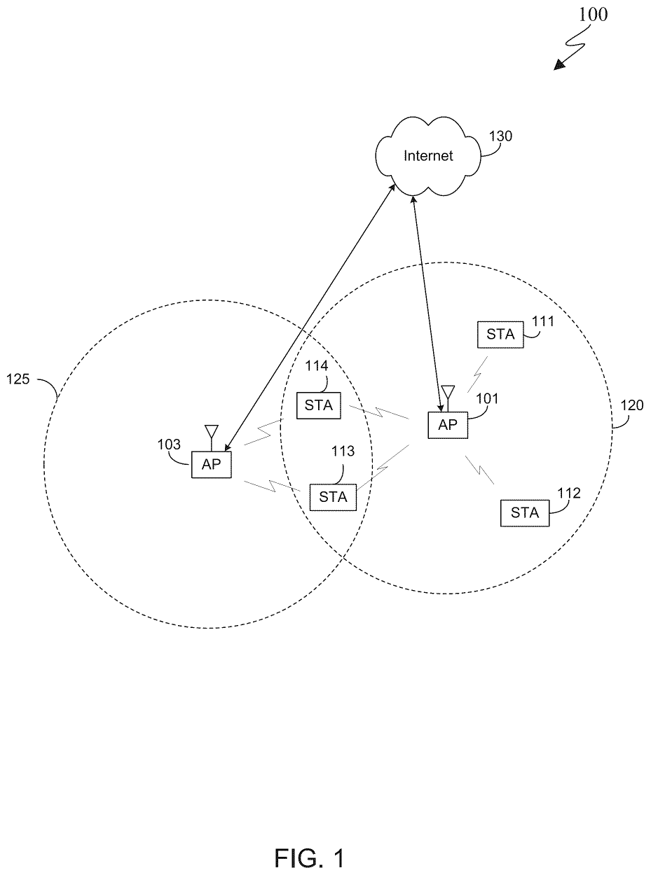

FIGS. 1 through 28, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following documents and standards descriptions are hereby incorporated by reference into the present disclosure as if fully set forth herein: [1] IEEE 802.11-2020, “Wireless LAN Medium Access Control (MAC) and Physical Layer (PHY) Specification”; [2] IEEE P802.11ax/D8.0; [3] IEEE P802.11be/D3.0.

FIG. 1 illustrates an example wireless network 100 according to various embodiments of the present disclosure. The embodiment of the wireless network 100 shown in FIG. 1 is for illustration only. Other embodiments of the wireless network 100 could be used without departing from the scope of this disclosure.

The wireless network 100 includes access points (APs) 101 and 103. The APs 101 and 103 communicate with at least one network 130, such as the Internet, a proprietary Internet Protocol (IP) network, or other data network. The AP 101 provides wireless access to the network 130 for a plurality of stations (STAs) 111-114 within a coverage area 120 of the AP 101. The APs 101-103 may communicate with each other and with the STAs 111-114 using WI-FI or other WLAN communication techniques. The STAs 111-114 may communicate with each other using peer-to-peer protocols, such as Tunneled Direct Link Setup (TDLS).

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Dotted lines show the approximate extents of the coverage areas 120 and 125, which are shown as approximately circular for the purposes of illustration and explanation only. It should be clearly understood that the coverage areas associated with APs, such as the coverage areas 120 and 125, may have other shapes, including irregular shapes, depending upon the configuration of the APs and variations in the radio environment associated with natural and man-made obstructions.

As described in more detail below, one or more of the APs may include circuitry and/or programming for facilitating link recommendation for meeting QoS requirements. Although FIG. 1 illustrates one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101-103 could communicate directly with the network 130 and provide STAs with direct wireless broadband access to the network 130. Further, the APs 101 and/or 103 could provide access to other or additional external networks, such as external telephone networks or other types of data networks.

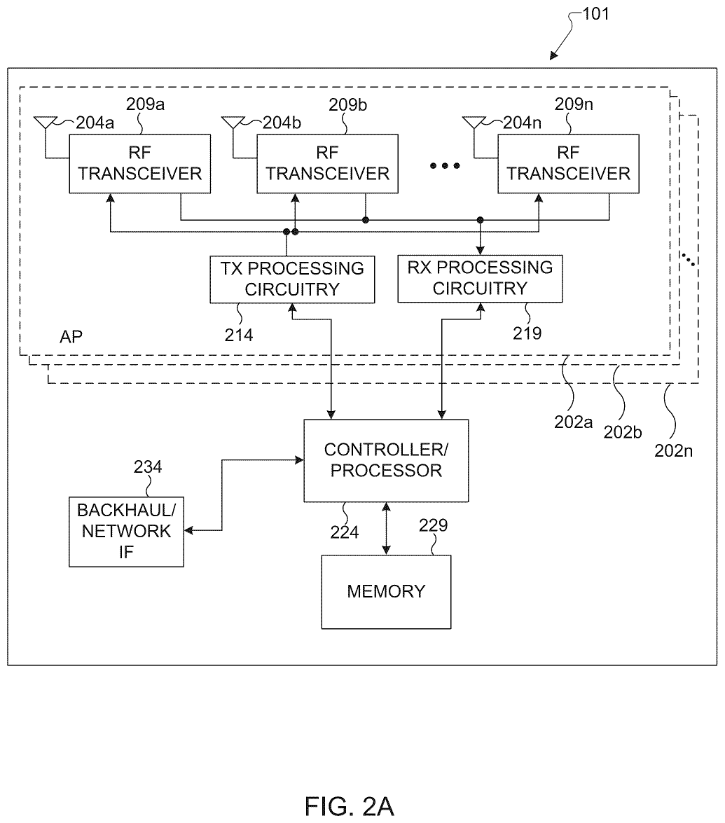

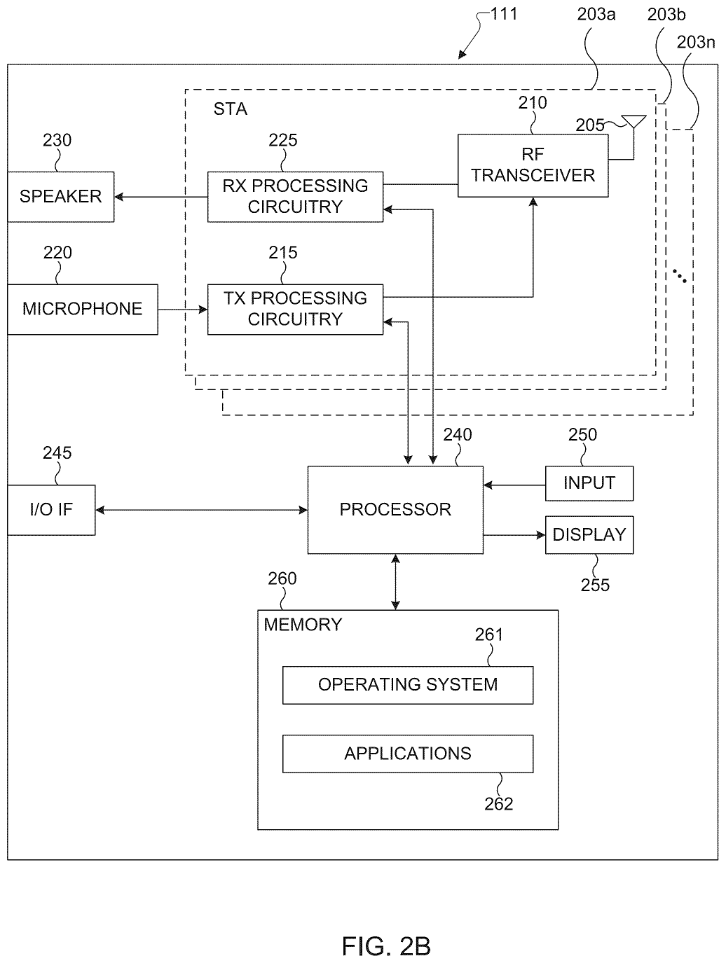

FIG. 2A illustrates an example AP 101 according to various embodiments of the present disclosure. The embodiment of the AP 101 illustrated in FIG. 2A is for illustration only, and the AP 103 of FIG. 1 could have the same or similar configuration. However, APs come in a wide variety of configurations, and FIG. 2A does not limit the scope of this disclosure to any particular implementation of an AP.

The AP 101 includes multiple antennas 204a-204n and multiple transceivers 209a-209n. The AP 101 also includes a controller/processor 224, a memory 229, and a backhaul or network interface 234. The transceivers 209a-209n receive, from the antennas 204a-204n, incoming radio frequency (RF) signals, such as signals transmitted by STAs 111-114 in the network 100. The transceivers 209a-209n down-convert the incoming RF signals to generate IF or baseband signals. The IF or baseband signals are processed by receive (RX) processing circuitry in the transceivers 209a-209n and/or controller/processor 224, which generates processed baseband signals by filtering, decoding, and/or digitizing the baseband or IF signals. The controller/processor 224 may further process the baseband signals.

Transmit (TX) processing circuitry in the transceivers 209a-209n and/or controller/processor 224 receives analog or digital data (such as voice data, web data, e-mail, or interactive video game data) from the controller/processor 224. The TX processing circuitry encodes, multiplexes, and/or digitizes the outgoing baseband data to generate processed baseband or IF signals. The transceivers 209a-209n up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of forward channel signals and the transmission of reverse channel signals by the transceivers 209a-209n in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including facilitating link recommendation for meeting QoS requirements. In some embodiments, the controller/processor 224 includes at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 includes any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for facilitating link recommendation for meeting QoS requirements. Although FIG. 2A illustrates one example of AP 101, various changes may be made to FIG. 2A. For example, the AP 101 could include any number of each component shown in FIG. 2A. As a particular example, an access point could include a number of interfaces 234, and the controller/processor 224 could support routing functions to route data between different network addresses. Alternatively, only one antenna and transceiver path may be included, such as in legacy APs. Also, various components in FIG. 2A could be combined, further subdivided, or omitted and additional components could be added according to particular needs.

FIG. 2B illustrates an example STA 111 according to various embodiments of the present disclosure. The embodiment of the STA 111 illustrated in FIG. 2B is for illustration only, and the STAs 111-115 of FIG. 1 could have the same or similar configuration. However, STAs come in a wide variety of configurations, and FIG. 2B does not limit the scope of this disclosure to any particular implementation of a STA.

The STA 111 includes antenna(s) 205, transceiver(s) 210, a microphone 220, a speaker 230, a processor 240, an input/output (I/O) interface (IF) 245, an input 250, a display 255, and a memory 260. The memory 260 includes an operating system (OS) 261 and one or more applications 262.

The transceiver(s) 210 receives, from the antenna(s) 205, an incoming RF signal (e.g., transmitted by an AP 101 of the network 100). The transceiver(s) 210 down-converts the incoming RF signal to generate an intermediate frequency (IF) or baseband signal. The IF or baseband signal is processed by RX processing circuitry in the transceiver(s) 210 and/or processor 240, which generates a processed baseband signal by filtering, decoding, and/or digitizing the baseband or IF signal. The RX processing circuitry sends the processed baseband signal to the speaker 230 (such as for voice data) or is processed by the processor 240 (such as for web browsing data).

TX processing circuitry in the transceiver(s) 210 and/or processor 240 receives analog or digital voice data from the microphone 220 or other outgoing baseband data (such as web data, e-mail, or interactive video game data) from the processor 240. The TX processing circuitry encodes, multiplexes, and/or digitizes the outgoing baseband data to generate a processed baseband or IF signal. The transceiver(s) 210 up-converts the baseband or IF signal to an RF signal that is transmitted via the antenna(s) 205.

The processor 240 can include one or more processors and execute the basic OS program 261 stored in the memory 260 in order to control the overall operation of the STA 111. In one such operation, the processor 240 controls the reception of forward channel signals and the transmission of reverse channel signals by the transceiver(s) 210 in accordance with well-known principles. The processor 240 can also include processing circuitry configured to facilitate link recommendation for meeting QoS requirements. In some embodiments, the processor 240 includes at least one microprocessor or microcontroller.

The processor 240 is also capable of executing other processes and programs resident in the memory 260, such as operations for facilitating link recommendation for meeting QoS requirements. The processor 240 can move data into or out of the memory 260 as required by an executing process. In some embodiments, the processor 240 is configured to execute a plurality of applications 262, such as applications for facilitating link recommendation for meeting QoS requirements. The processor 240 can operate the plurality of applications 262 based on the OS program 261 or in response to a signal received from an AP. The processor 240 is also coupled to the I/O interface 245, which provides STA 111 with the ability to connect to other devices such as laptop computers and handheld computers. The I/O interface 245 is the communication path between these accessories and the processor 240.

The processor 240 is also coupled to the input 250, which includes for example, a touchscreen, keypad, etc., and the display 255. The operator of the STA 111 can use the input 250 to enter data into the STA 111. The display 255 may be a liquid crystal display, light emitting diode display, or other display capable of rendering text and/or at least limited graphics, such as from web sites. The memory 260 is coupled to the processor 240. Part of the memory 260 could include a random-access memory (RAM), and another part of the memory 260 could include a Flash memory or other read-only memory (ROM).

Although FIG. 2B illustrates one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the processor 240 could be divided into multiple processors, such as one or more central processing units (CPUs) and one or more graphics processing units (GPUs). Also, while FIG. 2B illustrates the STA 111 configured as a mobile telephone or smartphone, STAs could be configured to operate as other types of mobile or stationary devices.

Various embodiments of the present disclosure recognize that upon receiving QoS requirements from a non-AP MLD for one or more traffic streams, the AP MLD may try to meet the requested QoS requirements for that non-AP MLD. In the process, the AP MLD may determine that the currently available link resources or the negotiated TWT resources are insufficient to meet the requested QoS requirements. However, the AP may also determine that using additional links or more TWT memberships by the non-AP MLD may help in meeting the QoS requirements.

Various embodiments of the present disclosure recognize that current IEEE 802.11 specifications are unclear about how to resolve the following issues within the EMLSR and EMLMR modes of operation: (i) how to indicate separately whether an MLD is capable of performing frame exchanges with another MLD that is operating in EMLSR mode and whether the MLD itself is capable of operating in EMLSR mode; (ii) how to indicate separately whether an MLD is capable of performing frame exchanges with another MLD that is operating in EMLMR mode and whether the MLD itself is capable of operating in EMLMR mode; (iii) when an EMLMR STA is performing uplink transmissions on one link can another EMLMR STA simultaneously perform uplink transmission; (iv) when an EMLMR STA performs an operating mode change using an operating mode notification frame to update the bandwidth or NSS, how does this impact the EMLMR operating procedure.

Accordingly, various embodiments of the present disclosure propose a mechanism for an AP MLD to indicate to the non-AP MLD that the currently used links or negotiated TWTs may be insufficient to meet the QoS requirements requested by the non-AP MLD. Mechanisms to indicate the suggested additional or alternative links to be used for meeting the QoS requirements are also provided. Further, various embodiments of the present disclosure propose a mechanism for an AP affiliated with an AP MLD to recommend a STA affiliated with a non-AP MLD to wake up STAs operating on other links to retrieve BUs when the traffic buffer at the AP MLD is large.

An Access point (AP) may have many different types of associated non-AP stations (STAs) each having their own traffic patterns and traffic requirements. To meet the varied requirements of different traffic flows of a non-AP STA, the specification [1] also provides a stream classification service (SCS). SCS allows a rule classifier to be defined based on parameters in protocol headers (layer 2 and/or layer 3). The classification allows the UP, drop eligibility, and enhanced distribution channel access (EDCA) transmit queue to be selected for all media access control service data units (MSDUs) matching the classification. A non-AP STA can request the AP to apply specific QoS treatment of downlink IP data flows using the classifier. The AP can use this to classify incoming individually addressed MSDUs. This rule-based classification of different traffic streams allows prioritization of the packets of one traffic stream over other streams, by enhancing its channel access or allocated resources.

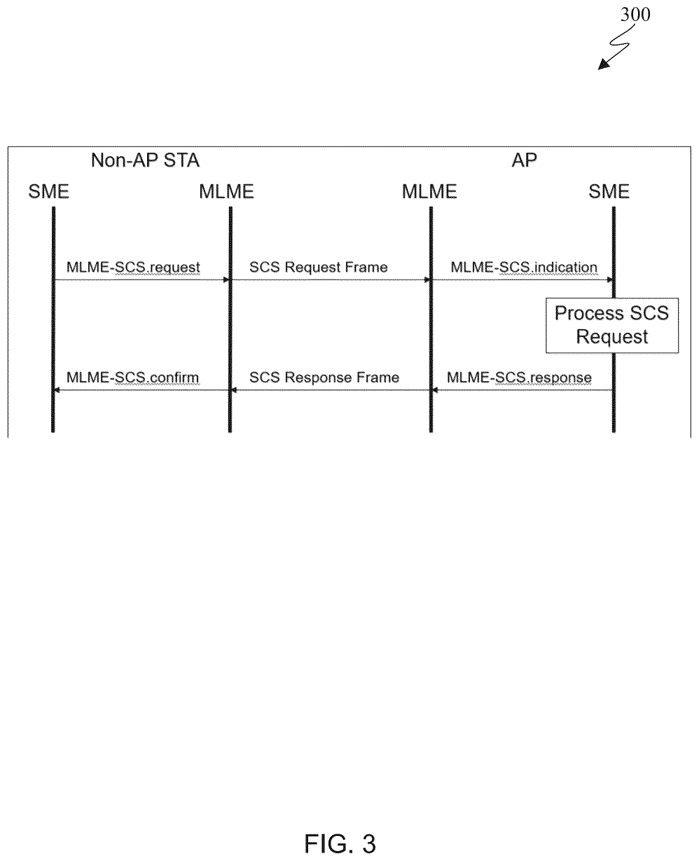

FIG. 3 illustrates an example frame exchange sequence for the SCS negotiation between a non-AP STA and an AP 300 according to embodiments of the present disclosure. The embodiment of the example frame exchange sequence for the SCS negotiation between a non-AP STA and an AP 300 shown in FIG. 3 is for illustration only. Other embodiments of the example frame exchange sequence for the SCS negotiation between a non-AP STA and an AP 300 could be used without departing from the scope of this disclosure.

The SCS negotiation procedure involves transmission of an SCS Request frame first by a non-AP STA and transmission of an SCS Response frame by the corresponding AP, and the frame exchange procedure is illustrated in FIG. 3.

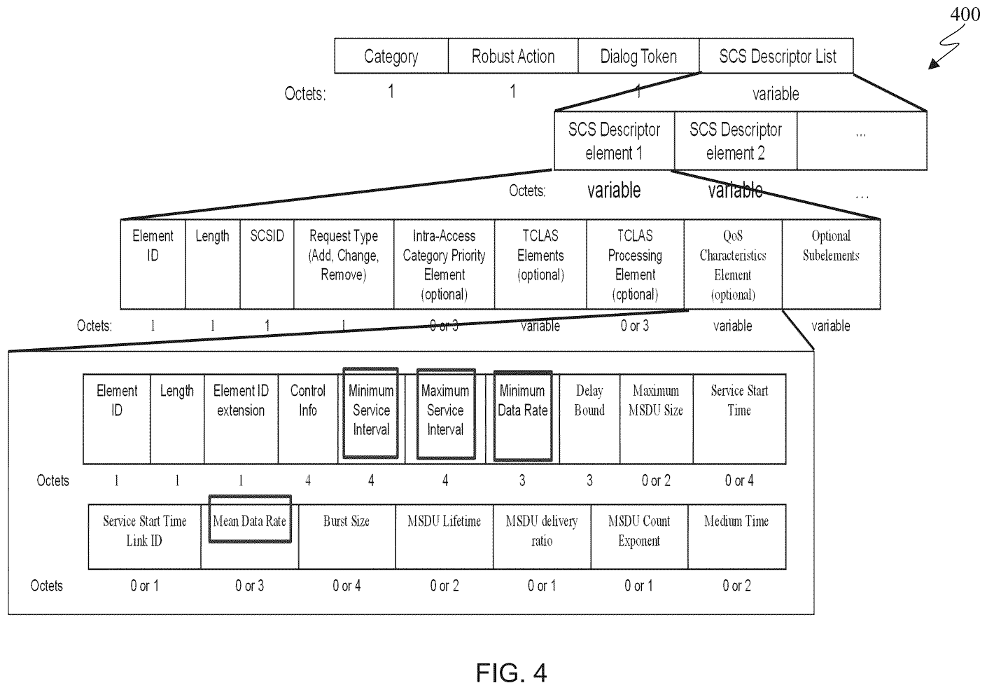

FIG. 4 illustrates an example SCS Request frame format 400 according to embodiments of the present disclosure. The embodiment of the example SCS Request frame format 400 shown in FIG. 4 is for illustration only. Other embodiments of the example SCS Request frame format 400 could be used without departing from the scope of this disclosure.

The Intra-Access Category Priority Element provides information on relative priorities of streams within an AC. The traffic classification (TCLAS) Element contains a set of parameters necessary to identify various kinds of protocol data unit (PDU) or incoming MSDU (from a higher layer in all STAs or from the DS in an AP) that belong to a particular TS. The TCLAS Processing Element together with the TCLAS element specifies how a PDU or MSDU should be processed by the classifier. The QoS characteristic element contains a set of parameters that define the characteristics and QoS expectations of a traffic flow.

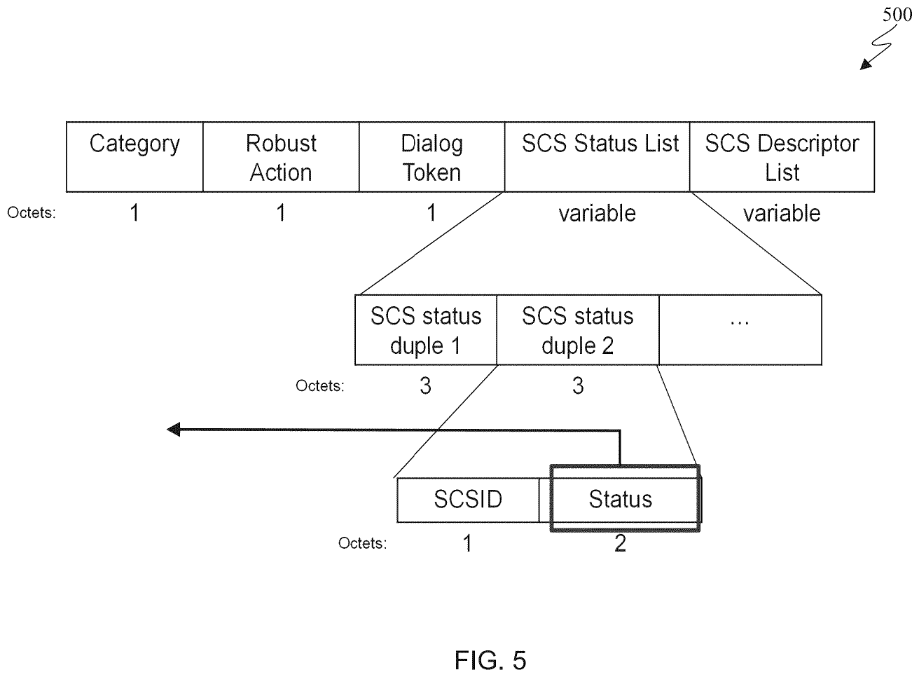

FIG. 5 illustrates an example SCS Response frame format 500 according to embodiments of the present disclosure. The embodiment of the example SCS Response frame format 500 shown in FIG. 5 is for illustration only. Other embodiments of the example SCS Response frame format 500 could be used without departing from the scope of this disclosure.

IEEE 802.11be [3] supports multiple bands of operation, where an access point (AP) and a non-AP device can communicate with each other, called links. Thus, both the AP and non-AP device may be capable of communicating on different bands/links, which is referred to as multi-link operation (MLO). Devices capable of such MLO are referred to as multi-link devices (MLDs). Upon associating with an AP MLD on a set of links (called setup links), each such non-AP device is assigned a unique association identifier (AID).

An MLD may also serve several different types of traffic categories having a different requirement on throughput, latency, etc. To enable traffic differentiation each traffic category can be assigned a traffic identifier (TID). For prioritization of channel access to different TIDs on the different links, and to limit contention, the AP MLD and non-AP MLD may also negotiate a TID-to-link mapping for such MLO. Such a TID-to-link mapping would identify, for each link, which TIDs are eligible for transmission/reception. Note that the default TID-to-link mapping allows any TID to be transmitted on any link.

To manage the traffic corresponding to different TIDs within a basic service set (BSS), the 802.11be [3] spec also defines a Link Recommendation frame. This frame can be transmitted by an AP affiliated with an AP MLD to a STA affiliated with a non-AP MLD to recommend one or more links to be used by the non-AP MLD to perform uplink and downlink data transmissions.

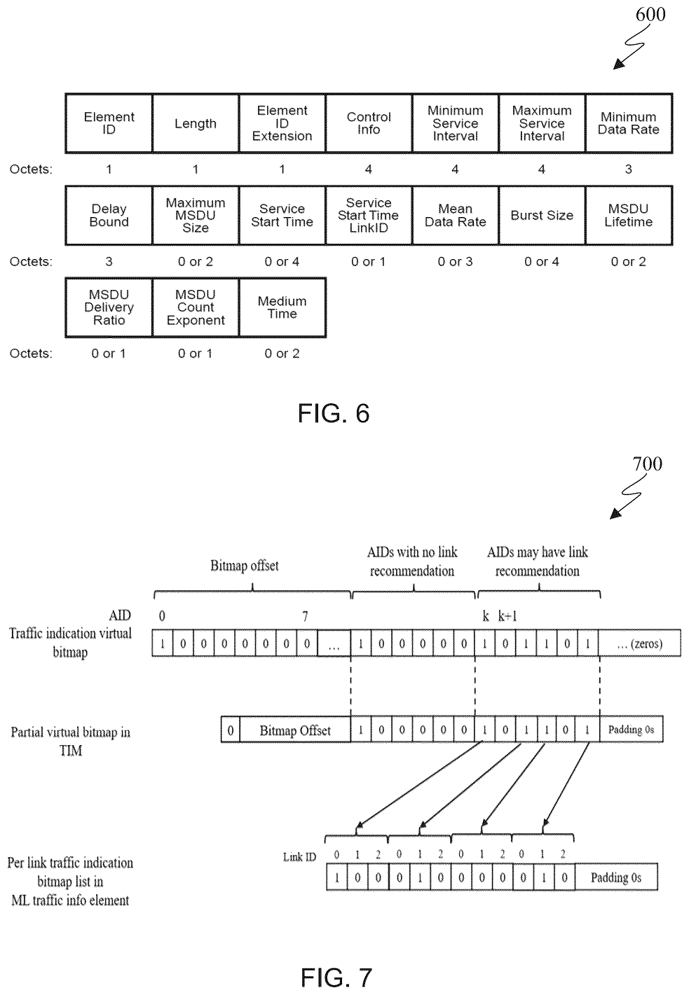

FIG. 6 illustrates an example format of the QoS Characteristics element 600 according to embodiments of the present disclosure. The embodiment of the example format of the QoS Characteristics element 600 shown in FIG. 6 is for illustration only. Other embodiments of the example format of the QoS Characteristics element 600 could be used without departing from the scope of this disclosure.

To enable a non-AP MLD to satisfy its QoS requirements without relying on the non-AP's channel contention mechanism, the spec [3] also proposed the QoS Characteristics element. By transmitting a QoS Characteristics element in an SCS Request frame, the non-AP MLD can indicate the different requirements for its traffic such as, the periodicity of channel access, minimum service interval, delay bound, mean data rate, maximum MSDU size etc. An illustration of the format of the QoS Characteristics element is provided in FIG. 5. An extra high throughput (EHT) AP tries to ensure that these QoS characteristics are met either by scheduling downlink transmissions to the non-AP MLD and allocating triggered uplink resources to the non-AP MLD in TWT service periods (SPs) or to STAs of the non-AP MLD in active mode. An EHT AP should schedule transmission of downlink frames such that the delay bound, and minimum data rate requested are met for the downlink Data frames if the Direction subfield of the QoS Characteristics element indicates downlink. An EHT AP should enable the transmission of uplink frames from the EHT STA with an interval that falls between the requested minimum and maximum service intervals and the AP should meet the minimum data rate requested if the Direction subfield of the QoS Characteristics element indicates uplink.

A WiFi station (STA) can be in one of two states:
1. awake state—when it continuously monitors the channel and can transmit or receive packets
2. doze state—when it does not monitor the channel, for example, for the purpose of saving power.

A non-AP STA can be in one of two power management modes:
1. Active mode: The STA receives and transmits frames at any time. The STA remains in the awake state.
2. Power save (PS) mode: The STA enters the awake state to receive or transmit frames. The STA remains in the doze state otherwise.

To allow non-AP devices to save power, the spec [1-3] also supports several power-save methods that determine how a STA behaves when in power save (PS) mode, and how it transitions between power save mode and active mode. These include Normal power save (PS), automatic power save delivery (APSD), wireless network management (WNM) power save, Power-save multi-poll mode, Spatial multiplexing PS, independent BSS (IBSS) power save, very high throughput (VHT) transmit opportunity (TXOP) Power Save, Target Wake Time (TWT), etc. During this time, the corresponding AP of the AP MLD buffers “buffer-able packets” that are addressed to the STA of the non-AP MLD, called buffered units (BUs). To indicate to all the associated non-AP devices about such pending BUs via a broadcast or multi-cast signaling, each AP of the AP MLD periodically includes a traffic information map (TIM) element within the beacon frames it transmits and, optionally, also as a separate periodic broadcast TIM frame. If there is pending buffered traffic for a non-AP MLD at the AP MLD, each AP affiliated with an AP MLD shall indicate pending buffered traffic for that non-AP MLD by setting the bit corresponding to the non-AP MLD's AID to 1 in the partial virtual bitmap of the TIM element.

Since with a non-default TID-to-link mapping all BUs can't be fetched on any set-up link, the spec [2] also provisions transmission of a new multi-link traffic indication element to indicate the link where the BUs can be fetched. An AP affiliated with an AP MLD shall include the Multi-Link Traffic Indication element in a Beacon frame it transmits if at least one of the associated non-AP MLD has successfully negotiated a TID-to-link mapping. The Multi-Link Traffic Indication element includes Per-Link Traffic Indication Bitmap subfield(s) which correspond to the AID(s) of the non-AP MLD(s) or STA(s), starting from the bit number k of the traffic indication virtual bitmap. The order of the Per-Link Traffic Indication Bitmap subfield(s) follows the order of the AID bits that are set to 1 in the Partial Virtual Bitmap subfield of the TIM element. For each such AID set to 1, I bits are reserved in the per-link traffic indication bitmap, where I is the number of associated links of the AP MLD. If a non-AP MLD has a non-default TID-to-link mapping with an AP MLD, the bit position i of the Per-Link Traffic Indication Bitmap subfield corresponding to the AID of the non-AP MLD shall be set to 1 if the AP MLD has buffered BU(s) with TID(s) mapped to that link or MMPDU(s) for that non-AP MLD, otherwise the bit shall be set to 0. In the non-AP has a default TID-to-link mapping then the bit position i of the Per-Link Traffic Indication Bitmap subfield shall be set to 1 if the AP MLD has buffered BU(s) and the non-AP MLD should use link i to retrieve the BU, i.e., recommendation.

This baseline indication of the link recommendation in the multi-link traffic indication element is depicted in FIG. 7, which illustrates an example multi-link traffic indication element operation 700 according to embodiments of the present disclosure. The embodiment of the example multi-link traffic indication element operation 700 shown in FIG. 7 is for illustration only. Other embodiments of the example multi-link traffic indication element operation 700 could be used without departing from the scope of this disclosure.

In order to ensure that the non-AP MLD fetches such BUs in a timely fashion, the non-AP MLD also negotiates a listen interval with the corresponding AP MLD. The Listen Interval field is used to indicate to the AP MLD how often at least a STA affiliated with a non-AP MLD wakes to listen to Beacon frames if all STAs affiliated with the non-AP MLD are in power save mode. Listening to the TIM and multi-link traffic indication element in such a beacon frame, the non-AP MLD may know about pending traffic buffered at the AP MLD. Upon noting that the bit corresponding to its AID is set to 1 in the TIM element, the non-AP MLD may decode the multi-link traffic indication element to interpret on which link(s) it is recommended to fetch the buffered BUs. Correspondingly one or more STAs of the non-AP MLD may transition to active mode and transmit a PS poll, unscheduled automatic power save delivery (U-APSD) trigger frame etc. to fetch the buffered downlink traffic from the affiliated AP. When an AP affiliated with an AP MLD receives a PS-Poll frame or a U-APSD trigger frame from a STA affiliated with an associated non-AP MLD that is in power save mode, it shall transmit buffered BU(s) to the STA, if one is available and not discarded for implementation dependent reasons, otherwise it may transmit a QoS Null frame. After initiating a frame exchange sequence with a STA of a non-AP MLD that is in power save mode to transmit BUs, the affiliated AP uses the More Data subfield in the frame control field of a transmitted data frame to indicate to a non-AP STA whether more individually addressed BUs are buffered for that non-AP MLD. The indicated buffered BUs (not including the BU currently being transmitted) are buffered at the AP MLD for the non-AP MLD and correspond to Data frames with TIDs that are mapped to this link or Management frames that are not a TPC Request frame or a Link Measurement Request frame. If no such frames are pending, i.e., if the More Data subfield is set to 0, then the STA of the non-AP MLD can go back to doze state after the end of the frame exchange sequence.

For each of its links, a non-AP MLD indicates a set of supported maximum number of spatial streams (NSS) and modulation and coding scheme (MCS) in the “EHT-MCS Map” subfield of the “Supported EHT MCS and NSS Set” field of the EHT capabilities element. The Supported EHT-MCS and NSS Set does not solely determine the number of spatial streams an MLD can transmit or receive. The 802.11 2020 draft [1] also defines a power saving mechanism for any STA called “operating mode change”. By using an operating mode change, a STA can change its operating bandwidth and/or the maximum NSS that it can support. Thus, it can save power by reducing bandwidth or the number of spatial streams when required.

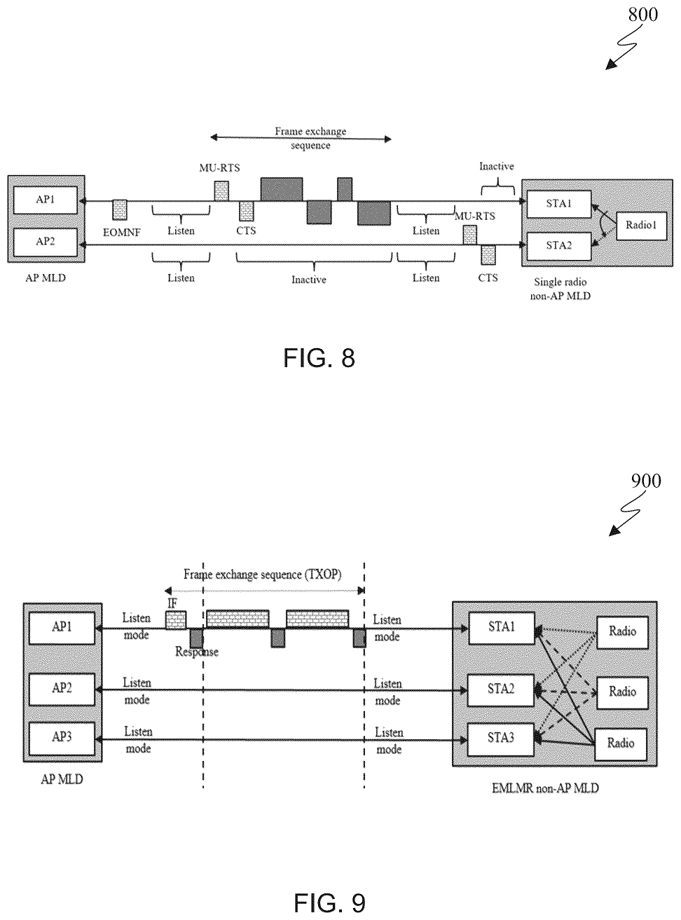

FIG. 8 illustrates an example of EMLSR operation for a two-link non-AP MLD 800 according to various embodiments of the present disclosure. The embodiment of the example of EMLSR operation for a two-link non-AP MLD 800 shown in FIG. 8 is for illustration only. Other embodiments of the example of EMLSR operation for a two-link non-AP MLD 800 could be used without departing from the scope of this disclosure.

For improving channel access capability with limited hardware cost and power consumption or to improve spectral efficiency, IEEE 802.11be also supports an operating mode for a non-AP MLD device called enhanced multi-link single radio (EMLSR) mode. In EMLSR mode, a non-AP device behaves like a single radio device that can perform channel sensing and reception of elementary packets on multiple bands/links simultaneously, but can perform reliable data communication on only one link at a time. Thus, by opportunistically selecting a link for data-communication where it wins the channel contention, EMLSR can improve system spectral efficiency. The operating procedure for EMLSR links is defined in the current 802.11be standard draft [2] and is illustrated in FIG. 8. According to this procedure, a non-AP MLD and an AP MLD may declare their ability to support EMLSR operation and the corresponding operation parameters in the enhanced multi-link (EML) capabilities subfield of the basic variant multi-link element that is shared with each other during the association process. If both the AP MLD and non-AP MLD support EMLSR, then to initiate EMLSR operation, a non-AP MLD first transmits an EML Operating Mode Notification Frame (EOMNF), with the EML control field of the frame set to 1, to any AP affiliated with the AP MLD. The EOMNF may contain several parameters for the EMLSR operation including the identity of the links that shall be considered for the EMLSR mode. Within a fixed delay (indicated in the transition timeout subfield of the EML capabilities subfield of the basic variant multi-link element) of transmitting the EOMNF, the non-AP MLD shall transition into the EMLSR mode by turning all its STAs associated with EMLSR to active and listen mode. In such a listen mode the EMLSR non-AP MLD is capable of channel sensing and reception of elementary packets. Upon winning a transmit opportunity (TXOP) on any one of the links associated with the non-AP MLD EMLSR mode, the AP MLD may initiate the frame exchange with the non-AP MLD by transmitting an initial control frame on that link. In FIG. 8, this control frame is a multi-user request-to-send (MU-RTS) frame transmitted on link1. After receiving the initial control frame from the AP MLD on a certain link, and after a short delay, the non AP MLD shall be capable of transmitting and receiving data on that link for the duration of the frame exchange sequence. All other EMLSR enabled links of the non-AP MLD shall remain inactive for the duration of the frame exchange sequence (such as link 2 in FIG. 8.). At the end of the frame exchange sequence, all the EMLSR enabled STAs of the non-AP MLD shall again switch back to the listen mode to either win a TXOP for uplink transmission, or look for another initial control frame from the AP MLD. To exit from an EMLSR operating mode the non-AP MLD shall transmit an EOMNF with the EML control field set to 0 to the AP MLD. After transmission of such an EOMNF from a link, the other links of the non-AP MLD shall transition into power save mode.

FIG. 9 illustrates an example of EMLMR operation for a two-link non-AP MLD 900 according to various embodiments of the present disclosure. The embodiment of the example of EMLMR operation for a two-link non-AP MLD 900 shown in FIG. 9 is for illustration only. Other embodiments of the example of EMLMR operation for a two-link non-AP MLD 900 could be used without departing from the scope of this disclosure.

For improving the supported MCS and NSS opportunistically and thus to improve spectral efficiency, IEEE 802.11be also supports an operating mode for a non-AP MLD device called enhanced multi-link multi-radio (EMLMR) mode. Upon start of a frame exchange sequence with the AP on a first link, a non-AP MLD in EMLMR mode can move radios across from its other links the first link, to improve the supported MCS and NSS on that link. The set of links at an EMLMR non-AP MLD that have this capability to move radios to/from are referred to as EMLMR links. The operating procedure for a non-AP MLD in EMLMR mode is defined in the current 802.11be standard draft [2] and is illustrated in FIG. 9. According to this procedure, a non-AP MLD and an AP MLD may declare their ability to support EMLMR operation and the corresponding operation parameters, in the enhanced multi-link (EML) capabilities subfield of the basic variant multi-link element that is shared with each other during the association process. If both the AP MLD and non-AP MLD support EMLMR operation, then to initiate EMLMR operation, a STA of the non-AP MLD first transmits an EML Operating Mode Notification Frame (EOMNF), with the “EMLMR mode” bit set to 1 in the EML control field of the frame, to the corresponding AP affiliated with the AP MLD. The EOMNF may contain several parameters for the EMLMR operation including the identity of the links that can be considered for the EMLMR mode, via the EMLMR Link bitmap field. In the EML control field of EML Operating Mode Notification Frame (EOMNF), the non-AP MLD also includes an “EMLMR supported MCS and NSS Set” subfield, that indicates (via an MCS map) for each channel BW the max supported MCS and NSS combinations in EMLMR mode, that are applicable for all EMLMR links. These values are referred to as “Enhanced MCS and NSS” in this document. Within a fixed delay (indicated in the transition timeout subfield of the EML capabilities subfield of the basic variant multi-link element) of transmitting the EOMNF, the non-AP MLD can transition into the EMLMR mode by turning all its STAs associated with EMLMR to active and listen mode. In such a listen mode, the EMLMR non-AP MLD is capable of channel sensing and transmitting and receiving packets on the EMLMR links at the basic MCS and NSS. Upon winning a transmit opportunity (TXOP) on any one of the EMLMR links associated with the non-AP MLD in EMLMR mode, the AP MLD may initiate the frame exchange with the non-AP MLD by transmitting an initial frame (IF) on that link with sufficient padding. In FIG. 9, this IF is a multi-user request-to-send (MU-RTS) frame transmitted on link1. After receiving the IF from the AP MLD on a certain link, the non AP MLD may be capable of transmitting and receiving data on that link for the duration of the frame exchange sequence at the enhanced MCS and NSS declared in the EOMNF. This is reception at the enhanced MCS and NSS accomplished by the EMLMR non-AP MLD switching-in radios from other links. The padding in the IF is to provide sufficient time for such switching, and this time is disclosed in the EMLMR delay subfield of the EML capabilities field of the basic variant multi-link element. At the end of the frame exchange sequence, all the EMLMR enabled STAs of the non-AP MLD may again switch back to the listen mode to either win a TXOP for uplink transmission, or look for another initial control frame from the AP MLD. To exit from an EMLMR operating mode, the non-AP MLD may transmit an EOMNF with the EMLMR mode bit of the EML control field set to 0 to the AP MLD.

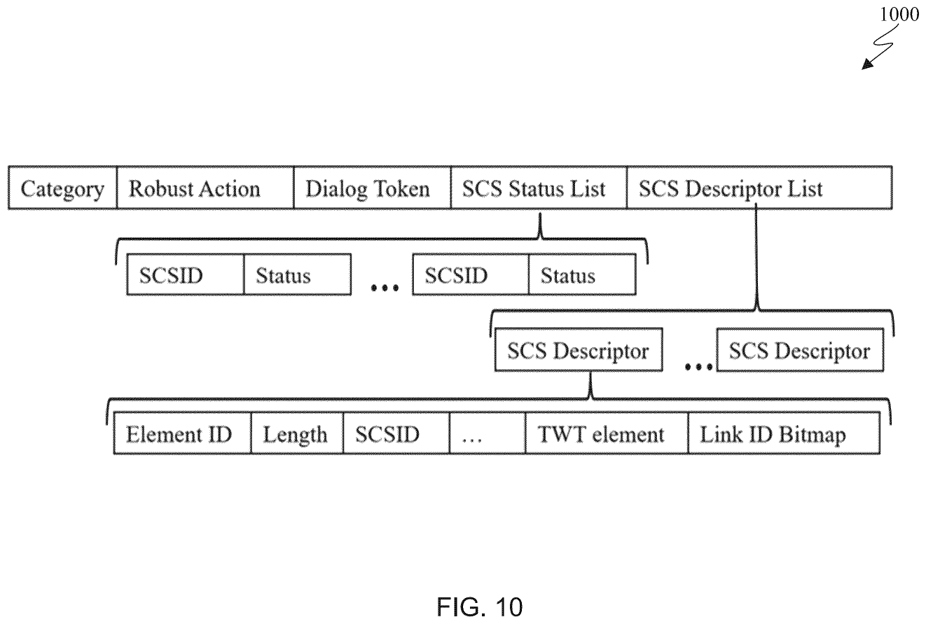

FIG. 10 illustrates an example of the SCS Response frame depicting the Status subfield 1000 according to various embodiments of the present disclosure. The embodiment of the example of the SCS Response frame depicting the Status subfield 1000 shown in FIG. 10 is for illustration only. Other embodiments of the example of the SCS Response frame 1000 depicting the Status subfield could be used without departing from the scope of this disclosure.

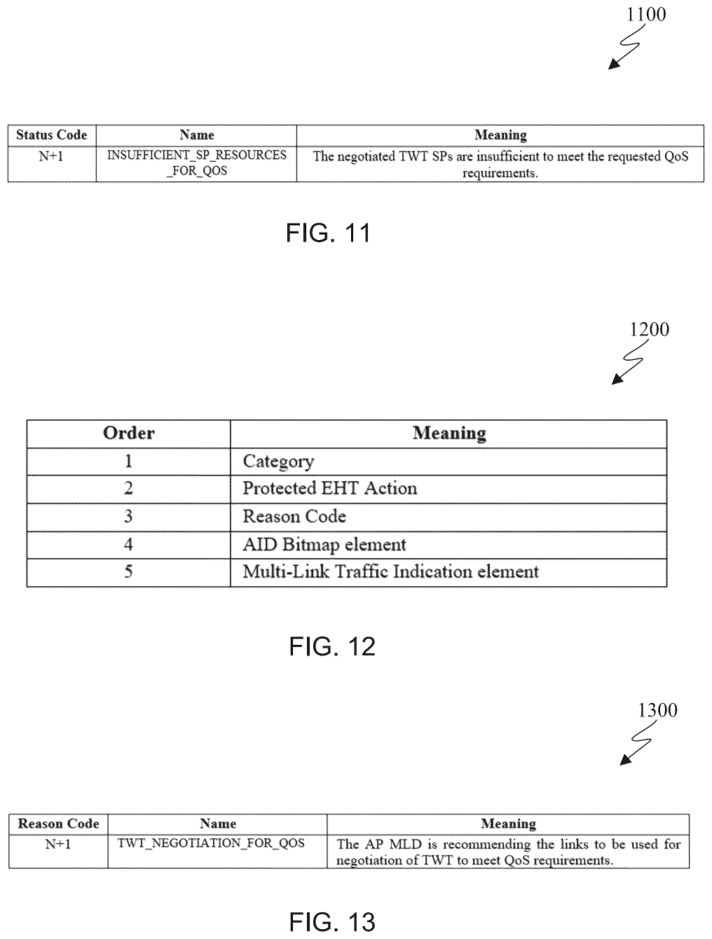

FIG. 11 illustrates an example of the Status code values to be used in SCS Response frame 1100 according to various embodiments of the present disclosure. The embodiment of the example of the Status code values to be used in SCS Response frame 1100 shown in FIG. 11 is for illustration only. Other embodiments of the example 1100 of the Status code values to be used in SCS Response frame could be used without departing from the scope of this disclosure.

It can be assumed that a non-AP MLD may have one or more traffic streams that may have stringent quality-of-service (QoS) requirements. The non-AP MLD may indicate these QoS requirements to the AP MLD so that the AP MLD can accordingly allocate resources to the non-AP MLD. These QoS requirements may be indicated by the non-AP MLD using, for example, the QoS Characteristics element carried in a Stream Classification Service (SCS) Request frame, or a TSPEC element, etc.

In one embodiment, in an SCS Request frame transmitted by a non-AP STA affiliated with a non-AP MLD to an AP MLD, the non-AP STA may indicate the list of links it is willing to use for satisfying the QoS parameters indicated in the QoS Characteristics element included in the SCS Request. This information can be carried in a Link ID Bitmap subfield of the SCS Request frame or the QoS Characteristics element.

In one embodiment, where the QoS requirement received from a non-AP MLD corresponds to a flow for which TWT has been negotiated by the non-AP MLD on one or more links, the AP MLD may determine if it can satisfy the requested QoS requirements using the already negotiated TWT SPs. If these SPs are insufficient, the AP MLD may indicate one or more of:
An indication that the TWT SPs that the non-AP MLD has negotiated are insufficient to meet the QoS requirements, and so the non-AP MLD should also consider using more TWT SPs, or the same or other links.
A set of links on which the non-AP MLD should set up TWT membership.
The AP may also indicate the parameters to be used for the TWT to be setup. This can be indicated, for example, by including a TWT element along with the above notification.
The non-AP MLD upon receiving such indication may set up additional TWT memberships on the recommended links to satisfy the QoS requirements. In a variant, the AP may indicate some of the links on which TWT is already negotiated as 0 to indicate that they may not be required to meet the QoS requirements of the non-AP MLD. In another variant, the AP may also include a TWT element to indicate the modifications to the existing TWT negotiations that are required to satisfy the QoS requirements.

In one example, the AP's indication may be carried in the Status subfield of the SCS Status List of the SCS Response frame, as depicted in FIG. 10. A new status code can be added for this indication, such as, INSUFFICIENT_SP_RESOURCES_FOR_QOS, as shown in FIG. 11. Upon receiving this indication in the SCS Response frame, the non-AP MLD may negotiate TWT membership on other links as well. In a variant of this example, the SCS Response frame may have an optional Link ID Bitmap subfield to indicate the set of links which are recommended by the AP to perform the negotiation of the additional TWT memberships. This can be carried, for example, within the SCS Descriptor element which carries the SCS ID corresponding to the QoS requirement. In a variant of this example, the SCS Response frame may have an optional TWT element subfield to indicate the suggested TWT parameters for the TWT memberships. This can be carried, for example, within the SCS Descriptor element which carries the SCS ID corresponding to the SCS.

FIG. 12 illustrates an example format of the Link Recommendation frame Action field 1200 according to various embodiments of the present disclosure. The embodiment of the example format of the Link Recommendation frame Action field 1200 shown in FIG. 12 is for illustration only. Other embodiments of the example format of the Link Recommendation frame Action field 1200 could be used without departing from the scope of this disclosure.

FIG. 13 illustrates an example of the Reason Code values corresponding to the purpose of the Link Recommendation 1300 according to various embodiments of the present disclosure. The embodiment of the example of the Reason Code values corresponding to the purpose of the Link Recommendation 1300 shown in FIG. 13 is for illustration only. Other embodiments of the example of the Reason Code values corresponding to the purpose of the Link Recommendation 1300 could be used without departing from the scope of this disclosure.

In another example, the AP's indication may be carried in a Link Recommendation frame transmitted to the non-AP MLD. In one variant, the indication of the purpose of the recommendation can be carried in the Reason Code field of the Link Recommendation frame. In another variant, there can be a separate field called Subtype field to indicate the purpose of the recommendation. For example, the format of the Link Recommendation frame can be as shown in FIG. 12 and the Reason Code can be as shown in FIG. 13, where N is the last defined assigned Reason Code value in the baseline spec. A new Reason Code can be defined such as TWT_NEGOTIATION_FOR_QOS to indicate that the recommendation is for links to set up new TWT memberships on to meet the QoS requirements. In one variant, the Link Recommendation frame may also have a Dialog Token to identify the SCS Request frame corresponding to which the Recommendation is being provided. In one variant, the Link Recommendation frame may also have a traffic identifier (TID) or Stream ID field to identify the TID or stream corresponding to which the Recommendation is being provided.

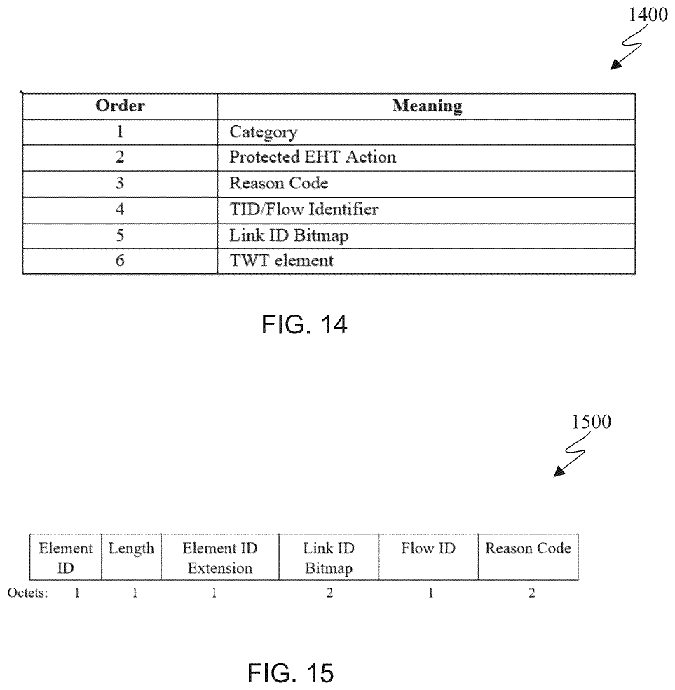

FIG. 14 illustrates an example format of an individually addressed action frame for link recommendation 1400 according to various embodiments of the present disclosure. The embodiment of the example format of an individually addressed action frame for link recommendation 1400 shown in FIG. 14 is for illustration only. Other embodiments of the example format of an individually addressed action frame for link recommendation 1400 could be used without departing from the scope of this disclosure.

FIG. 15 illustrates an example of a new element for indication of the individually addressed link recommendation 1500 according to various embodiments of the present disclosure. The embodiment of the example of a new element for indication of the individually addressed link recommendation 1500 shown in FIG. 15 is for illustration only. Other embodiments of the example of a new element for indication of the individually addressed link recommendation 1500 could be used without departing from the scope of this disclosure.

In another example, there can be a new Action frame for the individually addressed link recommendation. The format may be as depicted in FIG. 14. Here the TID or Flow ID may be used to identify the flow or the TID for which the TWTs are recommended to be negotiated. Alternatively, an identifier for the QoS characteristics element that corresponds to the recommendation may be provided. The encoding and use of the Reason Code field may be similar to FIG. 13. In a variant, this can be a vendor-specific action frame.

In another example, a new element may be used for individually addressed indication of a set of recommended links. This element may again have a Reason Code or SubType subfield to indicate the reason for the recommendation as explained in the above example. Here the Flow ID may be used to identify the flow for which the TWTs are recommended to be negotiated. Alternatively, an identifier for the QoS characteristics element that corresponds to the recommendation may be provided. The format of this element can be, for example, as shown in FIG. 15. In a variant, this element may be a variant of the MLO Link Information element. In another variant, this can be a vendor-specific element.

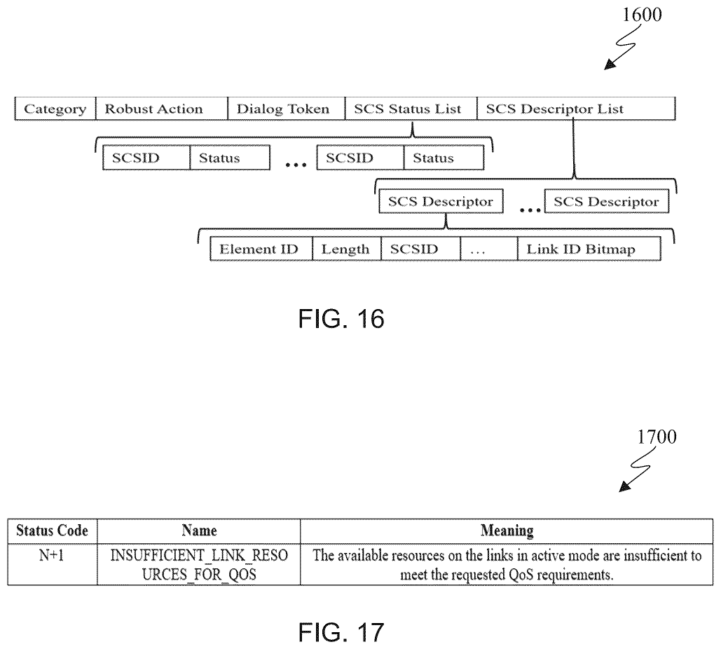

FIG. 16 illustrates another example of the SCS Response frame depicting the Status subfield 1600 according to various embodiments of the present disclosure. The embodiment of the example of the SCS Response frame depicting the Status subfield 1600 shown in FIG. 16 is for illustration only. Other embodiments of the example of the SCS Response frame depicting the Status subfield 1600 could be used without departing from the scope of this disclosure.

FIG. 17 illustrates another example of the Status code values to be used in the SCS Response frame 1700 according to various embodiments of the present disclosure. The embodiment of the example of the Status code values to be used in the SCS Response frame 1700 in FIG. 17 is for illustration only. Other embodiments of the example of the Status code values to be used in the SCS Response frame 1700 could be used without departing from the scope of this disclosure.

In one embodiment, where the QoS requirements indicated by a non-AP MLD do not correspond to a TID or Traffic flow for which TWT has been negotiated by the non-AP MLD, the AP MLD may determine if it can satisfy the requested QoS requirements using just the links on which the STA is in active mode. If these links are insufficient, the AP MLD may indicate one or more of:
An indication that the links on which the non-AP MLD is currently in active mode are insufficient to meet the QoS requirements, and so the non-AP MLD should also consider using more links.
A set of links on which the non-AP MLD is in power save mode which should transition to active mode to meet the QoS requirements.
A set of disabled links of the non-AP MLD which should be enabled to meet the QoS requirements.

The non-AP MLD upon receiving such indication may transition additional STAs to active mode or may renegotiate TID-to-Link Mapping to enable additional links, etc. In a variant, the AP may indicate some of the links on which the non-AP MLD is already in active mode as 0 to indicate that they may not be required to be in active mode meet the QoS requirements of the non-AP MLD.

In one example, the AP's indication may be carried in the Status subfield of the SCS Status List of the SCS Response frame, as depicted in FIG. 16. A new status code can be added for this indication, such as, INSUFFICIENT_LINK_RESOURCES_FOR_QOS, as shown in FIG. 17. Upon receiving this indication in the SCS Response frame, the non-AP MLD may transition additional links to active mode or may make additional links to enabled links. In a variant of this example, the SCS Response frame may have an optional Link ID Bitmap subfield to indicate the set of links which are recommended by the AP to transition to active mode. This can be carried, for example, within the SCS Descriptor element which carries the SCS ID corresponding to the QoS requirement.

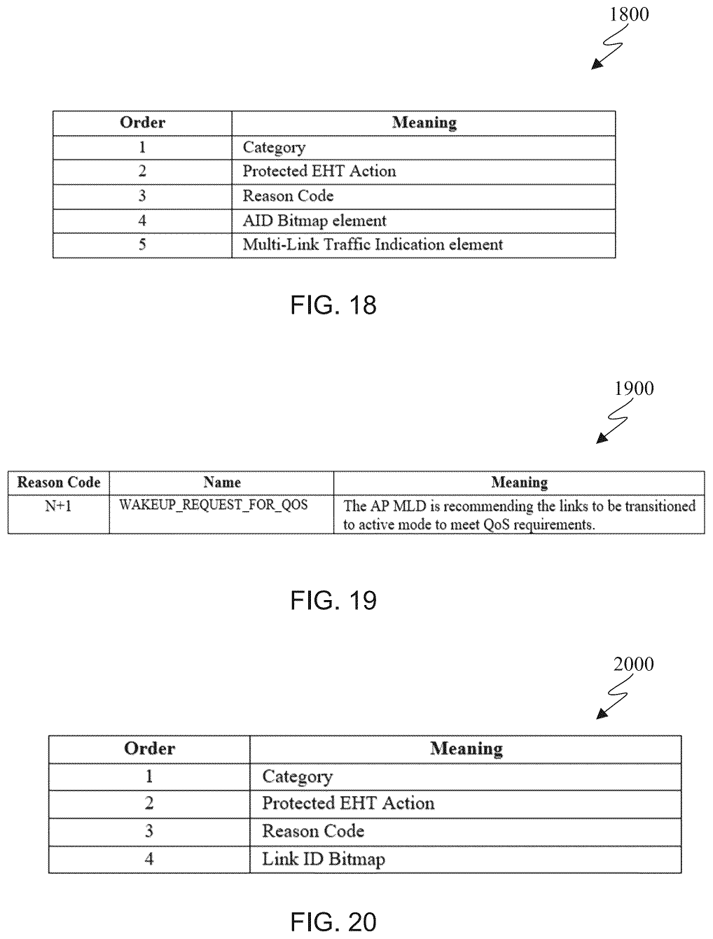

FIG. 18 illustrates another example format of the Link Recommendation frame Action field 1800 according to various embodiments of the present disclosure. The embodiment of the example format of the Link Recommendation frame Action field 1800 shown in FIG. 18 is for illustration only. Other embodiments of the example format of the Link Recommendation frame Action field 1800 could be used without departing from the scope of this disclosure.

FIG. 19 illustrates another example of the Reason Code values corresponding to the purpose of the Link Recommendation 1900 according to various embodiments of the present disclosure. The embodiment of the example of the Reason Code values corresponding to the purpose of the Link Recommendation 1900 shown in FIG. 19 is for illustration only. Other embodiments of the example of the Reason Code values corresponding to the purpose of the Link Recommendation 1900 could be used without departing from the scope of this disclosure.

In another example, the AP's indication may be carried in a Link Recommendation frame transmitted to the non-AP MLD. In one variant, the indication of the purpose of the recommendation can be carried in the Reason Code field of the Link Recommendation frame. In another variant, there can be a separate field called Subtype field to indicate the purpose of the recommendation. For example, the format of the Link Recommendation frame can be as shown in FIG. 18 and the Reason Code can be as shown in FIG. 19, where N is the last defined assigned Reason Code value in the baseline spec. A new Reason Code can be defined such as WAKE_UP_REQUEST_FOR_QOS to indicate that the recommendation is for links to be transitioned to active mode to meet the QoS requirements. In one variant, the Link Recommendation frame may also have a Dialog Token to identify the SCS Request frame corresponding to which the Recommendation is being provided. In one variant, the Link Recommendation frame may also have a traffic identifier (TID) or Stream ID field to identify the TID or stream corresponding to which the Recommendation is being provided.

FIG. 20 illustrates another example format of an individually addressed action frame for link recommendation 2000 according to various embodiments of the present disclosure. The embodiment of the example format of an individually addressed action frame for link recommendation 2000 shown in FIG. 20 is for illustration only. Other embodiments of the example format of an individually addressed action frame for link recommendation 2000 could be used without departing from the scope of this disclosure.

In yet another example, there can be a new Action frame for the individually addressed link recommendation. The format may be as depicted in FIG. 20. The encoding and use of the Reason Code field may be similar to FIG. 19. In a variant, this can be a user specific action frame.

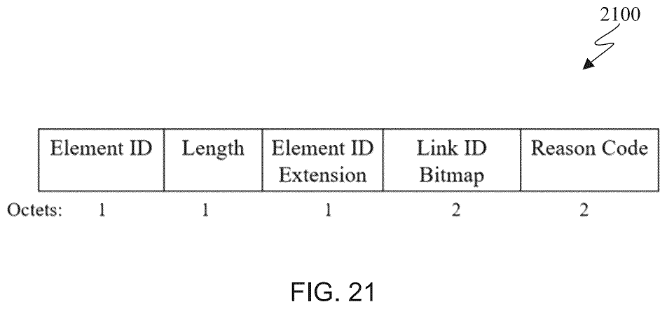

FIG. 21 illustrates another example of a new element for indication of the individually addressed link recommendation 2100 according to various embodiments of the present disclosure. The embodiment of the example of a new element for indication of the individually addressed link recommendation 2100 shown in FIG. 21 is for illustration only. Other embodiments of the example of a new element for indication of the individually addressed link recommendation 2100 could be used without departing from the scope of this disclosure.

In another example, a new element may be used for individually addressed indication of a set of recommended links. This element may again have a Reason Code or SubType subfield to indicate the reason for the recommendation as explained in the above example. The format of this element can be, for example, as shown in FIG. 21. In a variant, this element may be a variant of the MLO Link Information element. In another variant, this can be a vendor-specific element.

In one embodiment, the indication provided by the AP may be independent of whether a TWT has been negotiated for the traffic flow or not. The AP MLD may determine if it can satisfy the requested QoS requirements using either the TWTs negotiated or using the links on which the STA is in active mode. If these links are insufficient, the AP MLD may indicate one or more of:
An indication that the links on which the non-AP MLD is currently in active mode or the TWTs of which the non-AP MLD is a member are insufficient to meet the QoS requirements, and so the non-AP MLD should also consider using more links or TWTs.
A set of links on which the non-AP MLD is in power save mode which should either transition to active mode or negotiate for TWT memberships to meet the QoS requirements.
A set of disabled links of the non-AP MLD which should be enabled to meet the QoS requirements.
The AP may also indicate the parameters to be used for the TWT to be setup. This can be indicated, for example, by including a TWT element along with the above notification.

The non-AP MLD upon receiving such indication may transition additional STAs to active mode or may renegotiate TID-to-Link Mapping to enable additional links, or set up additional TWT memberships on the indicated links, etc. In a variant, the AP may indicate some of the links on which the non-AP MLD is already in active mode or has TWT negotiated as 0 to indicate that they may not be required to meet the QoS requirements of the non-AP MLD. In a variant, the AP may also include a TWT element to indicate the modifications to the existing TWT negotiations that are required to satisfy the QoS requirements.

In one example, the AP's indication may be carried in the Status subfield of the SCS Status List of the SCS Response frame. A new status code can be added for this indication, such as, INSUFFICIENT_RESOURCES_FOR_QOS. Upon receiving this indication in the SCS Response frame, the non-AP MLD may transition additional links to active mode or may make additional links to enabled links or may negotiate additional TWT memberships. In a variant of this example, the SCS Response frame may have an optional Link ID Bitmap subfield to indicate the set of links which are recommended by the AP to transition to active mode or set up additional TWTs. This can be carried, for example, within the SCS Descriptor element which carries the SCS ID corresponding to the QoS requirement. In a variant of this example, the SCS Response frame may have an optional TWT element subfield to indicate the suggested TWT parameters for the TWT memberships. This can be carried, for example, within the SCS Descriptor element which carries the SCS ID corresponding to the QoS requirement.

In another example, the AP's indication may be carried in a Link Recommendation frame transmitted to the non-AP MLD. In one variant, the indication of the purpose of the recommendation can be carried in the Reason Code field of the Link Recommendation frame. In another variant, there can be a separate field called Subtype field to indicate the purpose of the recommendation. For example, a new Reason Code can be defined such as LINK_RECOMMENDATION_FOR_QOS to indicate that the recommendation is for links to be transitioned to active mode or to be used for TWT negotiations to meet the QoS requirements. In one variant, the Link Recommendation frame may also have a Dialog Token to identify the SCS Request frame corresponding to which the Recommendation is being provided. In one variant, the Link Recommendation frame may also have a traffic identifier (TID) or Stream ID field to identify the TID or stream corresponding to which the Recommendation is being provided. Similarly, one or more of the other examples described herein may also be applicable to this embodiment.

In one embodiment, when the QoS requirement is no longer present, the AP MLD may provide an indication to the non-AP MLD that there is no longer a need to keep some of the STAs in active mode or to retain membership in specific TWTs. In one variant, this indication may be carried in an explicit frame transmitted by an AP affiliated with the AP MLD to a STA affiliated with the non-AP MLD. In another example, the indication can be implicit and may happen when the SCS negotiation is terminated by either the AP MLD or non-AP MLD. Upon receiving the indication the non-AP MLD may disable some STAs, transition some of its STAs to doze state or may terminate some TWT memberships.

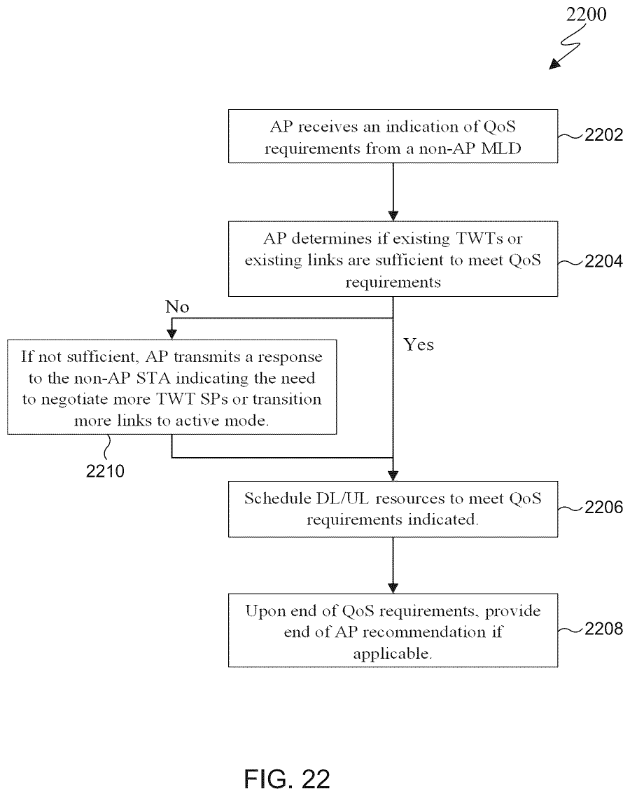

FIG. 22 illustrates an example flow diagram 2200 illustrating the sequence of steps performed by an AP to recommend the non-AP MLD to use more links or more TWTs for meeting QoS requirements according to various embodiments of the present disclosure. The embodiment of the example flow diagram 2200 illustrating the sequence of steps performed by an AP to recommend the non-AP MLD to use more links or more TWTs for meeting QoS requirements shown in FIG. 22 is for illustration only. Other embodiments of the example flow diagram 2200 illustrating the sequence of steps performed by an AP to recommend the non-AP MLD to use more links or more TWTs for meeting QoS requirements could be used without departing from the scope of this disclosure.

As illustrated in FIG. 22, the method begins at step 2202, where the AP receives an indication of QoS requirements from a non-AP MLD. At step 2204, the AP determines if existing TWTs or existing links are sufficient to meet QoS requirements. If existing TWTs or existing links are sufficient to meet QoS requirements, then at step 2206, the AP schedules DL/UL resources to meet the QoS requirements indicated. Thereafter, at step 2208, upon the end of QoS requirements, the AP provides an end of AP recommendation if applicable. If existing TWTs or existing links are not sufficient to meet QoS requirements at step 2206, then at step 2210, the AP transmits a response to the non-AP STA indicating the need to negotiate more TWT SPs or transition more links to active mode. Thereafter, the method proceeds to steps 2206 and 2208 as described above.

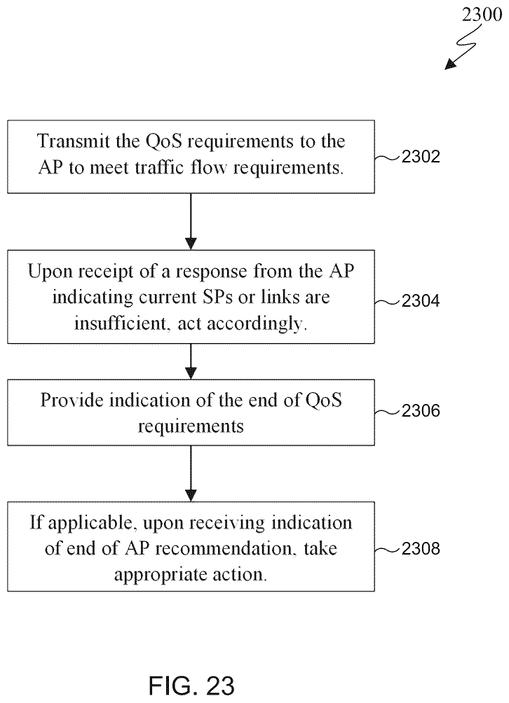

FIG. 23 illustrates an example flow diagram 2300 illustrating the sequence of steps performed by an STA to meet QoS requirements of its traffic according to various embodiments of the present disclosure. The embodiment of the example flow diagram 2300 illustrating the sequence of steps performed by an STA to meet QoS requirements of its traffic shown in FIG. 23 is for illustration only. Other embodiments of the example flow diagram 2300 illustrating the sequence of steps performed by an STA to meet QoS requirements of its traffic could be used without departing from the scope of this disclosure.

As illustrated in FIG. 23, the method begins at step 2302, where the STA transmits the QoS requirements to the AP to meet traffic flow requirements. At step 2304, the STA, upon receipt of a response from the AP indicating current SPs or links are insufficient, acts accordingly (e.g., negotiates more TWT SPs or transitions more links to active mode). At step 2306, the STA provides an indication of the end of QoS requirements. At step 2308, the STA, if applicable, upon receiving indication of an end of AP recommendation, takes appropriate action such as transitioning to doze state or may terminating some TWT memberships.

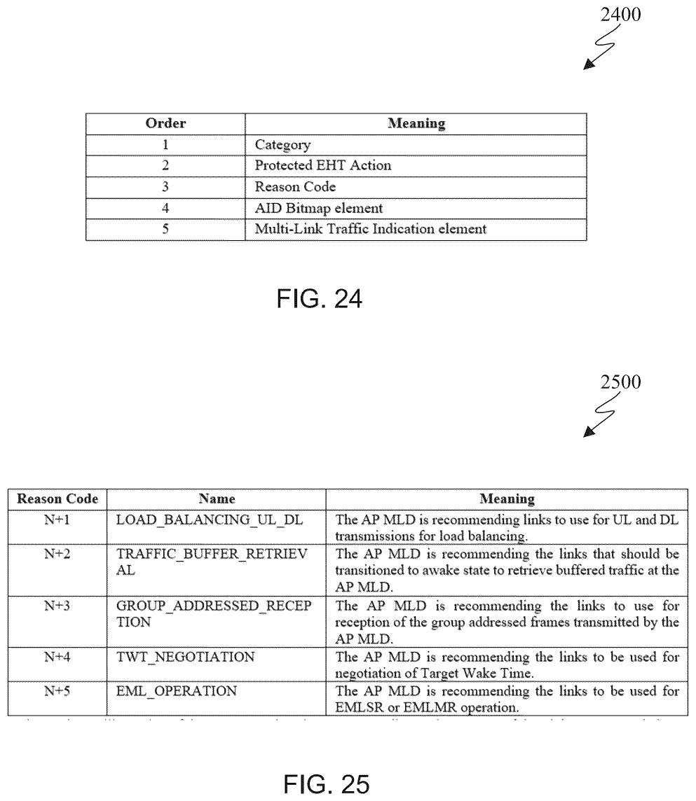

FIG. 24 illustrates yet another example format of the Link Recommendation frame Action field 2400 according to various embodiments of the present disclosure. The embodiment of the example format of the Link Recommendation frame Action field 2400 shown in FIG. 24 is for illustration only. Other embodiments of the example format of the Link Recommendation frame Action field 2400 could be used without departing from the scope of this disclosure.

FIG. 25 illustrates yet another example of the Reason Code values corresponding to the purpose of the Link Recommendation 2500 according to various embodiments of the present disclosure. The embodiment of the example of the Reason Code values corresponding to the purpose of the Link Recommendation 2500 shown in FIG. 25 is for illustration only. Other embodiments of the example of the Reason Code values corresponding to the purpose of the Link Recommendation 2500 could be used without departing from the scope of this disclosure.

### Status Code for Link Recommendation Frame:

In one embodiment, an AP affiliated with an AP MLD may transmit a Link Recommendation frame to one or more associated non-AP MLDs to recommend:
A set of links to be used for uplink and downlink transmissions for the purpose of load balancing.
A set of links to be used to retrieve the buffered traffic at the AP MLD.
A set of links to be used for group-addressed frame reception.
A set of links to be used for Target Wake Time negotiations.
A set of links to be used for EMLSR/EMLMR operations, etc.

In one embodiment, the indication of the purpose of the recommendation can be carried in the Reason Code field of the Link Recommendation frame. In another embodiment, there can be a separate field called Subtype field to indicate the purpose of the recommendation. For example, the format of the Link Recommendation frame can be as shown in FIG. 24 and the Status Code can be as shown in FIG. 25, where N is the last defined assigned Reason Code value in the baseline spec.

In one embodiment the non-AP MLD may behave differently based on the indicated reason code for the recommendation. For example, in one embodiment, upon reception of a Status Code LOAD_BALANCING_UL_DL, any STA affiliated with the non-AP MLD that is operating on one of the recommended links may be used to transmit frames to the AP MLD or receive frames from the AP MLD. The links not indicated in the recommended link set may be avoided for performing frame exchanges. In another example, upon reception of a Status Code TRAFFIC_BUFFER_RETRIEVAL, all the STAs affiliated with the non-AP MLD that are recommended may transition to awake state by sending a PS poll or U-APSD trigger frame to the corresponding AP of the AP MLD.

### Multi-Link Traffic Indication Element:

In one embodiment, if a non-AP MLD that (i) is in the default mapping mode or (ii) has a non-default mapping with all TIDs mapped to same link set, detects that the bit corresponding to its AID is equal to 1 in the TIM element and the Multi-Link Traffic Indication (MLTI) element is present in a Beacon frame and the Multi-Link Traffic Indication element includes a Per-Link Traffic Indication Bitmap n subfield that corresponds to the non-AP MLD, the non-AP MLD may operate as follows:
If all bits of the Per-Link Traffic Indication Bitmap n subfield are set to 0, all non-AP STAs affiliated with the non-AP MLD operating on enabled links may issue a PS-Poll frame, or a U-APSD trigger frame if the STA is using U-APSD and all ACs are delivery enabled, to retrieve buffered BU(s) from the AP MLD.
If not all bits of the Per-Link Traffic Indication Bitmap n subfield are set to 0, any non-AP STA affiliated with the non-AP MLD that operates on the link(s) indicated as 1 in the Per-Link Traffic Indication Bitmap n subfield may issue a PS-Poll frame, or a U-APSD trigger frame if the STA is using U-APSD and all ACs are delivery enabled, to retrieve buffered BU(s) from the AP MLD.

In another embodiment, if a non-AP MLD that is in the default mapping mode detects that the bit corresponding to its AID is equal to 1 in the TIM element and the Multi-Link Traffic Indication element is present in a Beacon frame and the Multi-Link Traffic Indication element includes a Per-Link Traffic Indication Bitmap n subfield that corresponds to the non-AP MLD, the non-AP MLD may operate as follows:
If all bits of the Per-Link Traffic Indication Bitmap n subfield are set to 1, all non-AP STAs affiliated with the non-AP MLD operating on enabled links may issue a PS-Poll frame, or a U-APSD trigger frame if the STA is using U-APSD and all ACs are delivery enabled, to retrieve buffered BU(s) from the AP MLD.
If all bits of the Per-Link Traffic Indication Bitmap n subfield are set to 0, any non-AP STAs affiliated with the non-AP MLD and operating on enabled links may issue a PS-Poll frame, or a U-APSD trigger frame if the STA is using U-APSD and all ACs are delivery enabled, to retrieve buffered BU(s) from the AP MLD.
If not all bits of the Per-Link Traffic Indication Bitmap n subfield are set to 0 and not all bits of the Per-Link Traffic Indication Bitmap n subfield are set to 1, any non-AP STA affiliated with the non-AP MLD that operates on the link(s) indicated as 1 in the Per-Link Traffic Indication Bitmap n subfield may issue a PS-Poll frame, or a U-APSD trigger frame if the STA is using U-APSD and all ACs are delivery enabled, to retrieve buffered BU(s) from the AP MLD.

In a variant of this embodiment if not all bits of the Per-Link Traffic Indication Bitmap n subfield are set to 0 and not all bits of the Per-Link Traffic Indication Bitmap n subfield are set to 1, the non-AP STA(s) affiliated with the non-AP MLD that operate on the link(s) indicated as 1 in the Per-Link Traffic Indication Bitmap n subfield may issue a PS-Poll frame, or a U-APSD trigger frame if the STA is using U-APSD and all ACs are delivery enabled, to retrieve buffered BU(s) from the AP MLD.

In one embodiment, if a non-AP MLD that has a non-default mapping mode where not all TIDs are mapped to the same link set detects that the bit corresponding to its AID is equal to 1 in the TIM element and the Multi-Link Traffic Indication element is present in a Beacon frame and the Multi-Link Traffic Indication element includes a Per-Link Traffic Indication Bitmap n subfield that corresponds to the non-AP MLD, the non-AP MLD may operate as follows:
If all bits of the Per-Link Traffic Indication Bitmap n subfield are set to 0, any non-AP STA affiliated with the non-AP MLD operating on an enabled link may issue a PS-Poll frame, or a U-APSD trigger frame if the STA is using U-APSD and all ACs are delivery enabled, to retrieve buffered BU(s) from the AP MLD.
If not all bits of the Per-Link Traffic Indication Bitmap n subfield are set to 0, the non-AP STA(s) affiliated with the non-AP MLD that operate on the link(s) indicated as 1 in the Per-Link Traffic Indication Bitmap n subfield may issue a PS-Poll frame, or a U-APSD trigger frame if the STA is using U-APSD and all ACs are delivery enabled, to retrieve buffered BU(s) from the AP MLD.

In one embodiment, the AP MLD may take the above rules into account in creating the Multi-link Traffic Indication element.

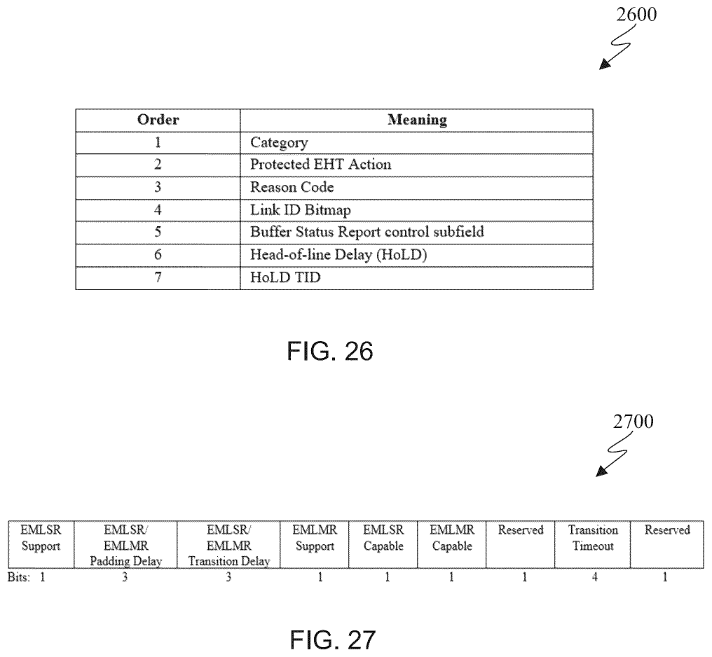

FIG. 26 illustrates an example format of the Multi-link Recommendation Request frame Action field 2600 according to various embodiments of the present disclosure. The embodiment of the example format of the Multi-link Recommendation Request frame Action field 2600 shown in FIG. 26 is for illustration only. Other embodiments of the example format of the Multi-link Recommendation Request frame Action field 2600 could be used without departing from the scope of this disclosure.

In one embodiment, the non-AP MLD may transmit a frame to the AP MLD to indicate the rules to determine if the number of BUs at the AP MLD are too large so that multiple STA(s) of the non-AP MLD should be woken up to retrieve the BIs. These rules may then be applied by the AP MLD in building the link recommendations in the MLTI element. This frame can be, for example, a new EHT Action frame called a Multi-link Recommendation Request frame. The frame can contain one or more of:
An indication of whether the non-AP MLD wants multi-link wake-up request recommendations for retrieving BUs.
An indication of the threshold on the buffer size beyond which all links should be recommended to be transitioned to awake state.
An indication of the threshold on head-of-line delay (HoLD), beyond which multiple links should be recommended to be transitioned to awake state.
An indication of the TIDs or access categories corresponding to which the indicated buffer size and/or HoLD thresholds apply.
A Buffer Status Report control field, that indicates the buffer size thresholds on a per TID or per access category basis.
A Traffic Classification (TCLAS) element indicating the streams which should be considered the multi-link retrieval recommendation.
A Frame Classifier element indicating the streams which should be considered for the multi-link wake-up recommendation, etc.
An indication of the parameters for combining the buffer sizes and HoLD corresponding to the different indicated access categories to make the determination.
A Link ID Bitmap indicating the candidate links to consider when performing the recommendation.

An example illustration of this EHT Action frame is depicted in FIG. 26.

FIG. 27 illustrates an example of the EML Capabilities subfield indicating separately the EMLSR Support, EMLSR Capable, EMLMR Support and EMLMR Capable subfields 2700 according to various embodiments of the present disclosure. The embodiment of the example of the EML Capabilities subfield indicating separately the EMLSR Support, EMLSR Capable, EMLMR Support and EMLMR Capable subfields 2700 in FIG. 27 is for illustration only. Other embodiments of the example of the EML Capabilities subfield indicating separately the EMLSR Support, EMLSR Capable, EMLMR Support and EMLMR Capable subfields 2700 could be used without departing from the scope of this disclosure.

### Indication of EMLSR Support, EMLSR Capability, EMLMR Support and EMLMR Capability:

In one embodiment, in the EML Capabilities subfield transmitted in the Common Info field of a Basic Multi-link element transmitted by a STA, there can be two subfields: EMLSR Support and EMLSR Capable, each of one bit. The format of the EML Capabilities subfield can be, for example, as depicted in FIG. 27. These indications can have the following meanings:
A STA affiliated with an MLD can set the EMLSR Support subfield of the EML Capabilities field to 1 to indicate that it is capable of performing frame exchanges with a STA affiliated with another MLD that is operating in EMLSR mode. Otherwise, the STA can set the EMLSR Support subfield to 0.
A STA affiliated with an MLD can set the EMLSR Capable subfield of the EML Capabilities field to 1 to indicate that the MLD is capable of operating in EMLSR mode. Otherwise, the STA can set the EMLSR Capable subfield to 0.

In one variant of this embodiment, the EMLSR Capable subfield can be set to 1 in the EML Capabilities field transmitted by a STA affiliated with an MLD only if the MLD can operate in EMLSR mode with the transmitting STA operating on one of the EMLSR links.

In one embodiment, in the EML Capabilities subfield transmitted in the Common Info field of a Basic Multi-link element transmitted by a STA, there can be two subfields: EMLMR Support and EMLMR Capable, each of one bit. The format of the EML Capabilities subfield can be, for example, as depicted in FIG. 27. These indications can have the following meanings:
A STA affiliated with an MLD can set the EMLMR Support subfield of the EML Capabilities field to 1 to indicate that it is capable of performing frame exchanges with a STA affiliated with another MLD that is operating in EMLMR mode. Otherwise, the STA can set the EMLMR Support subfield to 0.
A STA affiliated with an MLD can set the EMLMR Capable subfield of the EML Capabilities field to 1 to indicate that the MLD is capable of operating in EMLMR mode. Otherwise, the STA can set the EMLMR Capable subfield to 0.

In one variant of this embodiment, the EMLMR Capable subfield can be set to 1 in the EML Capabilities field transmitted by a STA affiliated with an MLD only if the MLD can operate in EMLMR mode with the transmitting STA operating on one of the EMLMR links.

Uplink Transmissions from Two EMLMR STAs:

In one embodiment, if a first EMLMR STA affiliated with an MLD operating in EMLMR mode, as the owner of a TXOP, initiates a frame exchange sequence with another STA affiliated with another device, the other EMLMR STAs of the MLD shall not initiate frame exchanges for the duration of that TXOP. In another embodiment, the other EMLMR STAs shall not initiate frame exchanges if the transmission by the first EMLMR STA in the TXOP satisfies one or more of the following conditions:
The transmission is soliciting reception of frames from the STA of the other device within the same TXOP. Examples of such transmissions can be: PS poll frame, QoS Null frame, U-APSD trigger frame.
The transmission is soliciting reception of frames from the STA of the other device that can be transmitted at a high MCS or NSS as indicated in the EMLMR MCS and NSS Map of the EML Operating Mode Notification frame transmitted to switch to EMLMR mode.
The transmission and the TXOP are shorter than a particular threshold.

In one embodiment, if during a TXOP initiated by a first EMLMR STA of an MLD operating in EMLMR mode, another EMLMR STA is determined to be allowed to initiate frame exchanges, the initiated frame exchange by the other EMLMR STA may satisfy one or more of the following rules:
The initiated frame exchange may not solicit reception of uplink frames. Examples of such restricted frames can be PS poll frame, QoS Null frame, U-APSD frame etc.
The frame exchange by the other EMLMR STA may be ended before the end of the TXOP on the first EMLMR link or it may perform end time alignment with the end of the TXOP initiated by the first EMLMR STA.

In one embodiment, if an EMLMR STA affiliated with a first MLD operating in EMLMR mode transmits a frame to a STA affiliated with another MLD as a TXOP holder, the other MLD may not transmit frames to the first MLD on any of the other EMLMR links for the duration of that TXOP.

### Implication of Operating Mode Notification and Operating Mode Indication on EMLMR Operation:

In one embodiment, an EMLMR STA affiliated with an MLD operating in EMLMR mode may not perform a change in its number of spatial streams (NSS) by transmitting an Operating Mode Notification frame or Operating Mode control field. In another embodiment, if a STA affiliated with an MLD operating in EMLMR mode transmits an Operating Mode Notification frame or an Operating Mode control field to update the NSS, the updated Rx NSS and Tx NSTS values may be applicable to any frames exchanged with the STA by the serving AP or any peer STA. In yet another embodiment, if a STA affiliated with an MLD operating in EMLMR mode transmits an Operating Mode Notification frame or an Operating Mode control field to update the NSS, the updated Rx NSS and Tx NSTS values may be applicable only to the initial frame of a frame exchange initiated with/by the STA, but may not be applicable to subsequent frames of the frame exchange. They may also be applicable for the frames exchanged after the MLD exits EMLMR mode.

In one embodiment, an EMLMR STA affiliated with an MLD operating in EMLMR mode may not perform a change in its Channel Width by transmitting an Operating Mode Notification frame or Operating Mode control field. In another embodiment, if a STA affiliated with an MLD operating in EMLMR mode transmits an Operating Mode Notification frame or an Operating Mode control field to update the Channel Width, the updated Channel Width may be applicable to any frames exchanged with the STA by the serving AP or any peer STA. In yet another embodiment, if a STA affiliated with an MLD operating in EMLMR mode transmits an Operating Mode Notification frame or an Operating Mode control field to update the Channel Width, the updated Channel Width values may be applicable only to the initial frame of a frame exchange initiated with/by the STA, but may not be applicable to subsequent frames of the frame exchange. They may also be applicable for the frames exchanged after the MLD exits EMLMR mode.

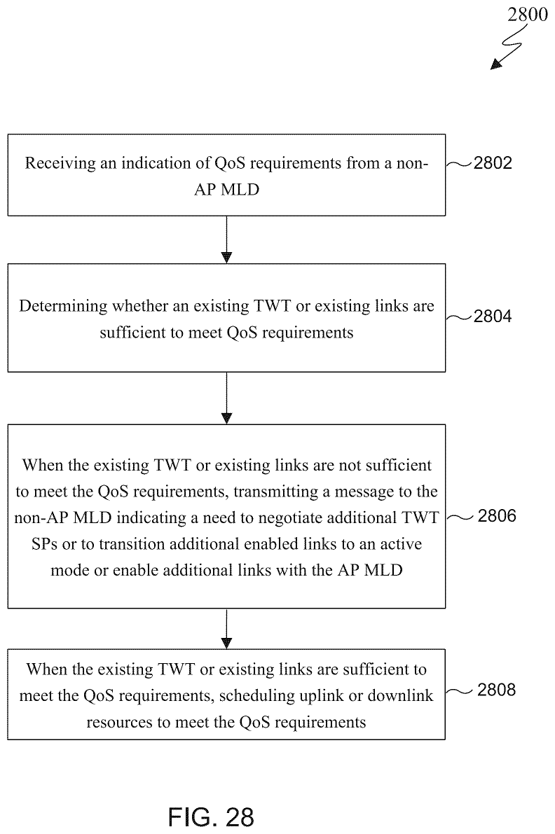

FIG. 28 illustrates a flow diagram of a method 2800 for wireless communication performed by an AP device according to embodiments of the present disclosure. The example method 2800 shown in FIG. 28 is for illustration only. Other embodiments of the example method 2800 could be used without departing from the scope of this disclosure.

As illustrated in FIG. 28, the method 2800 begins at step 2802, where the AP device receives an indication of QoS requirements from a non-AP MLD. At step 2804, the AP device determines whether an existing TWT or existing links are sufficient to meet QoS requirements. At step 2806, the AP device, when the existing TWT or existing links are not sufficient to meet the QoS requirements, transmits a message to the non-AP MLD indicating a need to negotiate additional TWT SPs or to transition additional enabled links to an active mode or enable additional links with the AP MLD. At step 2808, the AP device, when the existing TWT or existing links are sufficient to meet the QoS requirements, schedules uplink or downlink resources to meet the QoS requirements.

In one embodiment, the AP device receives information from the non-AP MLD indicating links that the non-AP MLD can use for satisfying the QoS requirements.

In one embodiment, when the QoS requirements correspond to a flow for which TWT has been negotiated by the non-AP MLD on one or more links, the AP device: determines whether the QoS requirements can be satisfied using already negotiated TWT SPs; when the QoS requirements cannot be satisfied using the already negotiated TWT SPs: the AP device indicates to the non-AP MLD that the already negotiated TWT SPs are insufficient to meet the QoS requirements, and to consider using additional TWT SPs or other links to meet the QoS requirements; or indicates to the non-AP MLD the links on which the non-AP MLD should set up TWT membership; and when the QoS requirements can be satisfied using the already negotiated TWT SPs, the AP device schedules the uplink or downlink resources to meet the QoS requirements.

In one embodiment, the AP device indicates parameters to be used for setup of additional TWT SPs or modification of existing TWT SPs.

In one embodiment, the AP device transmits an indication indicating one or more of: already negotiated TWT SPs are insufficient to meet the QoS requirements, or links on which the non-AP MLD should set up TWT membership, or that links on which the non-AP MLD is in active mode are insufficient to meet the QoS requirements, or links on which the non-AP MLD is in power save mode which should transition to active mode to meet the QoS requirements, or disabled links of the non-AP MLD which should be enabled to meet the QoS requirements, or that links on which the TWT of which the non-AP MLD is a member are insufficient to meet the QoS requirements, in a frame transmitted to the non-AP MLD.

In one embodiment, when the QoS requirements correspond to a flow for which TWT has not been negotiated by the non-AP MLD on one or more links, the AP device: determines whether the QoS requirements can be satisfied using only links on which the non-AP MLD is in active mode; when the QoS requirements cannot be satisfied using only links on which the non-AP MLD is in active mode: indicates to the non-AP MLD that the links on which the non-AP MLD is in active mode are insufficient to meet the QoS requirements, and to consider using additional links to meet the QoS requirements; or indicates to the non-AP MLD links on which the non-AP MLD is in power save mode which should transition to active mode to meet the QoS requirements; or indicates to the non-AP MLD disabled links of the non-AP MLD which should be enabled to meet the QoS requirements; and when the QoS requirements can be satisfied using only links on which the non-AP MLD is in active mode, schedules the uplink or downlink resources to meet the QoS requirements.

In one embodiment, the AP device: determines whether the QoS requirements can be satisfied using already negotiated TWT SPs or using only links on which the non-AP MLD is in active mode; when the QoS requirements cannot be satisfied using already negotiated TWT SPs or using only links on which the non-AP MLD is in active mode: indicates to the non-AP MLD that the links on which the non-AP MLD is in active mode or the TWT of which the non-AP MLD is a member are insufficient to meet the QoS requirements, and to consider using additional links or additional TWTs; indicates to the non-AP MLD links on which the non-AP MLD is in power save mode which should either transition to active mode or negotiate for TWT memberships to meet the QoS requirements; or indicates to the non-AP MLD disabled links of the non-AP MLD which should be enabled to meet the QoS requirements; and when the QoS requirements can be satisfied using already negotiated TWT SPs or using only links on which the non-AP MLD is in active mode, schedules the uplink or downlink resources to meet the QoS requirements.

In one embodiment, the AP device, upon determining that existing TWT negotiations are insufficient, indicates parameters to be used for setup of additional TWT SPs or modification of existing TWT SPs.

In one embodiment, the AP device, when the QoS requirements are no longer present, provides an indication to the non-AP MLD that there is no longer a need to keep one or more stations (STAs) associated with the non-AP MLD in an active mode or to retain membership in specific TWTs.

In one embodiment, the AP device transmits a frame to the non-AP MLD to recommend: links to be used for uplink and downlink transmissions for load balancing; links to be used to retrieve buffered traffic at the AP MLD; links to be used for group-addressed frame reception; links to be used for TWT negotiations; or links to be used for enhanced multi-link single radio/enhanced multi-link multi radio (EMLSR/EMLMR) operations.

The above flowcharts illustrate example methods that can be implemented in accordance with the principles of the present disclosure and various changes could be made to the methods illustrated in the flowchart. For example, while shown as a series of steps, various steps could overlap, occur in parallel, occur in a different order, or occur multiple times. In another example, steps may be omitted or replaced by other steps.

Although the present disclosure has been described with an exemplary embodiment, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A method of wireless communication performed by an access point (AP) associated with an AP multi-link device (MLD), the method comprising:
receiving an indication of quality of service (QoS) requirements from a non-AP MLD;
determining whether an existing target wake time (TWT) or existing links are sufficient to meet QoS requirements;
when the existing TWT or existing links are not sufficient to meet the QoS requirements, transmitting a message to the non-AP MLD indicating a need to negotiate additional TWT service periods (SPs) or to transition additional enabled links to an active mode or enable additional links with the AP MLD; and
when the existing TWT or existing links are sufficient to meet the QoS requirements, scheduling uplink or downlink resources to meet the QoS requirements.

2. The method of claim 1, further comprising receiving information from the non-AP MLD indicating links that the non-AP MLD can use for satisfying the QoS requirements.

3. The method of claim 1, wherein when the QoS requirements correspond to a flow for which TWT has been negotiated by the non-AP MLD on one or more links, the method further comprises:
determining whether the QoS requirements can be satisfied using already negotiated TWT SPs;
when the QoS requirements cannot be satisfied using the already negotiated TWT SPs:
indicating to the non-AP MLD that the already negotiated TWT SPs are insufficient to meet the QoS requirements, and to consider using additional TWT SPs or other links to meet the QoS requirements; or
indicating to the non-AP MLD the links on which the non-AP MLD should set up TWT membership; and
when the QoS requirements can be satisfied using the already negotiated TWT SPs, scheduling the uplink or downlink resources to meet the QoS requirements.

4. The method of claim 3, further comprising indicating parameters to be used for setup of additional TWT SPs or modification of existing TWT SPs.

5. The method of claim 1, further comprising transmitting an indication indicating one or more of: that already negotiated TWT SPs are insufficient to meet the QoS requirements, or links on which the non-AP MLD should set up TWT membership, or that links on which the non-AP MLD is in active mode are insufficient to meet the QoS requirements, or links on which the non-AP MLD is in power save mode which should transition to active mode to meet the QoS requirements, or disabled links of the non-AP MLD which should be enabled to meet the QoS requirements, or that links on which the TWT of which the non-AP MLD is a member are insufficient to meet the QoS requirements, in a frame transmitted to the non-AP MLD.

6. The method of claim 1, wherein when the QoS requirements correspond to a flow for which TWT has not been negotiated by the non-AP MLD on one or more links, the method further comprises:
determining whether the QoS requirements can be satisfied using only links on which the non-AP MLD is in active mode;
when the QoS requirements cannot be satisfied using only links on which the non-AP MLD is in active mode:
indicating to the non-AP MLD that the links on which the non-AP MLD is in active mode are insufficient to meet the QoS requirements, and to consider using additional links to meet the QoS requirements; or
indicating to the non-AP MLD links on which the non-AP MLD is in power save mode which should transition to active mode to meet the QoS requirements; or
indicating to the non-AP MLD disabled links of the non-AP MLD which should be enabled to meet the QoS requirements; and
when the QoS requirements can be satisfied using only links on which the non-AP MLD is in active mode, scheduling the uplink or downlink resources to meet the QoS requirements.

7. The method of claim 1, wherein determining whether the existing TWT or the existing links are sufficient to meet QoS requirements comprises:
determining whether the QoS requirements can be satisfied using already negotiated TWT SPs or using only links on which the non-AP MLD is in active mode;
when the QoS requirements cannot be satisfied using already negotiated TWT SPs or using only links on which the non-AP MLD is in active mode:
indicating to the non-AP MLD that the links on which the non-AP MLD is in active mode or the TWT of which the non-AP MLD is a member are insufficient to meet the QoS requirements, and to consider using additional links or additional TWTs;
indicating to the non-AP MLD links on which the non-AP MLD is in power save mode which should either transition to active mode or negotiate for TWT memberships to meet the QoS requirements; or
indicating to the non-AP MLD disabled links of the non-AP MLD which should be enabled to meet the QoS requirements; and
when the QoS requirements can be satisfied using already negotiated TWT SPs or using only links on which the non-AP MLD is in active mode, scheduling the uplink or downlink resources to meet the QoS requirements.

8. The method of claim 7, further comprising upon determining that existing TWT negotiations are insufficient, indicating parameters to be used for setup of additional TWT SPs or modification of existing TWT SPs.

9. The method of claim 1, further comprising:
when the QoS requirements are no longer present, providing an indication to the non-AP MLD that there is no longer a need to keep one or more stations (STAs) associated with the non-AP MLD in an active mode or to retain membership in specific TWTs.

10. The method of claim 1, further comprising transmitting a frame to the non-AP MLD to recommend:
links to be used for uplink and downlink transmissions for load balancing;
links to be used to retrieve buffered traffic at the AP MLD;
links to be used for group-addressed frame reception;
links to be used for TWT negotiations; or
links to be used for enhanced multi-link single radio/enhanced multi-link multi radio (EMLSR/EMLMR) operations.

11. An access point (AP) associated with an AP multi-link device (MLD), the AP comprising:
a transceiver; and
a processor operably coupled to the transceiver, the processor configured to:
receive an indication of quality of service (QoS) requirements from a non-AP MLD;
determine whether an existing target wake time (TWT) or existing links are sufficient to meet QoS requirements;
when the existing TWT or existing links are not sufficient to meet the QoS requirements, transmit a message to the non-AP MLD indicating a need to negotiate additional TWT service periods (SPs) or to transition additional enabled links to an active mode or enable additional links with the AP MLD; and
when the existing TWT or existing links are sufficient to meet the QoS requirements, schedule uplink or downlink resources to meet the QoS requirements.

12. The AP of claim 11, wherein the processor is further configured to receive information from the non-AP MLD indicating links that the non-AP MLD can use for satisfying the QoS requirements.

13. The AP of claim 11, wherein when the QoS requirements correspond to a flow for which TWT has been negotiated by the non-AP MLD on one or more links, and the processor is further configured to:
determine whether the QoS requirements can be satisfied using already negotiated TWT SPs;
when the QoS requirements cannot be satisfied using the already negotiated TWT SPs:
indicate to the non-AP MLD that the already negotiated TWT SPs are insufficient to meet the QoS requirements, and to consider using additional TWT SPs or other links to meet the QoS requirements; or
indicate to the non-AP MLD the links on which the non-AP MLD should set up TWT membership; and
when the QoS requirements can be satisfied using the already negotiated TWT SPs, schedule the uplink or downlink resources to meet the QoS requirements.

14. The AP of claim 13, wherein the processor is further configured to indicate parameters to be used for setup of additional TWT SPs or modification of existing TWT SPs.

15. The AP of claim 11, wherein the processor is further configured to transmit an indication indicating one or more of: already negotiated TWT SPs are insufficient to meet the QoS requirements, or links on which the non-AP MLD should set up TWT membership, or that links on which the non-AP MLD is in active mode are insufficient to meet the QoS requirements, or links on which the non-AP MLD is in power save mode which should transition to active mode to meet the QoS requirements, or disabled links of the non-AP MLD which should be enabled to meet the QoS requirements, or that links on which the TWT of which the non-AP MLD is a member are insufficient to meet the QoS requirements, in a frame transmitted to the non-AP MLD.

16. The AP of claim 11, wherein when the QoS requirements correspond to a flow for which TWT has not been negotiated by the non-AP MLD on one or more links, the processor is further configured to:
determine whether the QoS requirements can be satisfied using only links on which the non-AP MLD is in active mode;
when the QoS requirements cannot be satisfied using only links on which the non-AP MLD is in active mode:
indicate to the non-AP MLD that the links on which the non-AP MLD is in active mode are insufficient to meet the QoS requirements, and to consider using additional links to meet the QoS requirements; or
indicate to the non-AP MLD links on which the non-AP MLD is in power save mode which should transition to active mode to meet the QoS requirements; or
indicate to the non-AP MLD disabled links of the non-AP MLD which should be enabled to meet the QoS requirements; and
when the QoS requirements can be satisfied using only links on which the non-AP MLD is in active mode, schedule the uplink or downlink resources to meet the QoS requirements.

17. The AP of claim 11, wherein to determine whether the existing TWT or the existing links are sufficient to meet QoS requirements, the processor is configured to:
determine whether the QoS requirements can be satisfied using already negotiated TWT SPs or using only links on which the non-AP MLD is in active mode;
when the QoS requirements cannot be satisfied using already negotiated TWT SPs or using only links on which the non-AP MLD is in active mode:
indicate to the non-AP MLD that the links on which the non-AP MLD is in active mode or the TWT of which the non-AP MLD is a member are insufficient to meet the QoS requirements, and to consider using additional links or additional TWTs;
indicate to the non-AP MLD links on which the non-AP MLD is in power save mode which should either transition to active mode or negotiate for TWT memberships to meet the QoS requirements; or
indicate to the non-AP MLD disabled links of the non-AP MLD which should be enabled to meet the QoS requirements; and
when the QoS requirements can be satisfied using already negotiated TWT SPs or using only links on which the non-AP MLD is in active mode, schedule the uplink or downlink resources to meet the QoS requirements.

18. The AP of claim 17, wherein the processor is further configured, upon determining that existing TWT negotiations are insufficient, to indicate parameters to be used for setup of additional TWT SPs or modification of existing TWT SPs.

19. The AP of claim 11, wherein the processor is further configured, when the QoS requirements are no longer present, to provide an indication to the non-AP MLD that there is no longer a need to keep one or more stations (STAs) associated with the non-AP MLD in an active mode or to retain membership in specific TWTs.

20. The AP of claim 11, wherein the processor is further configured to transmit a frame to the non-AP MLD to recommend:
links to be used for uplink and downlink transmissions for load balancing;
links to be used to retrieve buffered traffic at the AP MLD;
links to be used for group-addressed frame reception;
links to be used for TWT negotiations; or
links to be used for enhanced multi-link single radio/enhanced multi-link multi radio (EMLSR/EMLMR) operations.
